(19) United States
(12) Patent Application Publication
(10) Pub. No.: US 2025/0319740 A1
(43) Pub. Date: Oct. 16, 2025

(54) THERMAL MANAGEMENT SYSTEM FOR ELECTRIC VEHICLE

(71) Applicant: INZICONTROLS CO., LTD, Siheung-si (KR)

(72) Inventors: Ji Hoon KANG, Siheung-si (KR); Hee Hwa Jeong, Siheung-si (KR); Seung Chan Ha, Siheung-si (KR); Seong Hyeon Kim, Siheung-si (KR)

(73) Assignee: INZICONTROLS CO., LTD, Siheung-si (KR)

(21) Appl. No.: 19/249,210

(22) Filed: Jun. 25, 2025

Related U.S. Application Data
(63) Continuation of application No. PCT/KR2023/021795, filed on Dec. 28, 2023.

(30) Foreign Application Priority Data
Dec. 29, 2022 (KR) 1020220188538
Dec. 29, 2022 (KR) 1020220188539

(51) Int. Cl. B60H 1/00

(52) U.S. Cl. CPC B60H 1/00392; B60H 1/00485; B60H 1/00907; B60H 1/00278; B60H 2001/00928

(57) ABSTRACT

The thermal management system for an electric vehicle according to an embodiment of the present invention may provide a thermal management system for an electric vehicle, comprising: a thermal management unit; a heat pump unit coupled to a lower portion of the thermal management unit; and a refrigerant-coolant heat exchanger disposed below the heat pump unit and fluidly connected to the heat pump unit and the thermal management unit. Here, the thermal management unit may include: a valve housing in which a coolant circulation channel is formed and a plurality of connection ports are provided; a first coolant control valve disposed on one side of the valve housing; and a second coolant control valve disposed on the other side of the valve housing.

### DESCRIPTION

### Technical Field

The present invention relates to a thermal management system for an electric vehicle, and more particularly, to a thermal management system for an electric vehicle that is configured to appropriately manage the temperatures of a battery pack, electric component module, and heat exchangers of an air-conditioning device by using coolant that exchanges heat with refrigerant of a heat pump unit, and that is further capable of performing various thermal management functions required in an electric vehicle by variably changing a flow pattern of a coolant circulation passage that circulates the coolant through the battery pack, the electric component module, and the heat exchangers of the air-conditioning device.

### Background Art

In general, technologies related to the battery pack, which is a core component of an electric vehicle, have been actively researched and developed even prior to the launch of electric vehicles.

In particular, recent studies have focused on lightweighting, miniaturization, shortening of charging time, and enhancement of safety of the battery pack.

However, it remains highly challenging to properly manage the temperature of the battery pack due to heat generated inside the battery pack during driving of the electric vehicle and fluctuations in external ambient temperature.

To address this issue, conventional electric vehicles are equipped with an additional heating and cooling system dedicated to maintaining the temperature of the battery pack at an optimal level.

As such, conventional electric vehicles typically employ two separate thermal management systems: one for cabin air-conditioning and the other for the battery pack.

This separation significantly increases the overall power consumption of the vehicle, resulting in a substantial drop in energy efficiency and a notable reduction in the driving range achievable on a single charge.

Accordingly, there is an urgent need to develop a technology for organically integrating the air-conditioning system, the battery pack, and the thermal management system for electric component module within the electric vehicle.

### DISCLOSURE

### Technical Problem

According to an embodiment of the present invention, a thermal management system for an electric vehicle is provided that is capable of appropriately managing the temperatures of a battery pack, electric component module, and heat exchangers of an air-conditioning device by using coolant that exchanges heat with refrigerant in a heat pump unit.

Accordingly, there is no need to provide an additional heating and cooling system dedicated to the battery pack or the electric component module, thereby simplifying the configuration of the thermal management system and reducing both manufacturing cost and overall system weight.

Furthermore, the embodiment of the present invention provides a thermal management system for an electric vehicle that is capable of flexibly performing various thermal management functions required in an electric vehicle by variably changing the flow pattern of a coolant circulation passage through which the coolant is circulated to the battery pack, the electric component module, and the heat exchangers of the air-conditioning device.

In addition, the embodiment of the present invention provides a thermal management system for an electric vehicle in which the heat pump unit and the temperature management unit are integrally coupled into a unified structure, so that the thermal management system may be manufactured in a compact and simplified form, thereby facilitating installation and improving maintenance efficiency.

### Technical Solution

According to an embodiment of the present invention, a thermal management system for an electric vehicle is provided. The system comprises: a temperature management unit; a heat pump unit coupled to a lower side of the temperature management unit; and a refrigerant-coolant heat exchanger disposed beneath the heat pump unit and fluidly connected to both the heat pump unit and the temperature management unit.

Here, the temperature management unit may comprise: a valve housing in which a coolant circulation passage is formed and a plurality of connection ports are provided; a first coolant control valve disposed on one side of the valve housing; and a second coolant control valve disposed on the other side of the valve housing.

Preferably, an axial direction of the first coolant control valve may be arranged to be orthogonal to an axial direction of the second coolant control valve.

Preferably, the heat pump unit may comprise a heat pump body coupled to a lower side of the temperature management unit, wherein a refrigerant circulation passage is formed in the heat pump body. The refrigerant-coolant heat exchanger may be installed on a lower side of the heat pump body. For example, the refrigerant-coolant heat exchanger may comprise a first refrigerant-coolant heat exchanger and a second refrigerant-coolant heat exchanger disposed adjacent to the first refrigerant-coolant heat exchanger.

Preferably, the temperature management unit may further comprise a reservoir formed in a chamber shape within the valve housing. The valve housing may comprise an upper body and a lower body. The reservoir may be integrally formed at an upper portion of the upper body.

Preferably, a first valve groove may be formed on one side of the valve housing. The first coolant control valve may comprise: a first coolant valve inserted into the first valve groove in a first axial direction and having a length in the first axial direction that is shorter than its diameter; and a first actuator connected to a rotation axis of the first coolant valve.

One or more first valve holes may be formed on a side surface of the first coolant valve, and a second valve hole may be formed on a bottom surface of the first coolant valve.

A space may be formed between a bottom surface of the first valve groove and the bottom surface of the first coolant valve. A tubular member may be disposed between the second valve hole and the bottom surface of the first valve groove.

Preferably, a second valve groove may be formed on the other side of the valve housing. The second coolant control valve may comprise: a second coolant valve inserted into the second valve groove in a second axial direction and having a length in the second axial direction that is greater than its diameter; and a second actuator connected to a rotation axis of the second coolant valve.

Preferably, the second coolant valve may comprise an upper layer, an intermediate layer, and a lower layer formed along the second axial direction from a top portion to a bottom portion. The upper layer may be formed as a structure isolated from the intermediate layer. The intermediate layer and the lower layer may be formed in a hollow cylindrical shape.

Preferably, the heat pump unit may comprise: a compressor configured to compress a refrigerant; an expansion valve configured to expand the refrigerant; a refrigerant switching valve connected between the compressor and the expansion valve and configured to switch a flow direction of the refrigerant; and a refrigerant bypass unit provided at the refrigerant switching valve and configured to bypass a portion of the refrigerant introduced into the refrigerant switching valve to an inlet side of the compressor.

Preferably, the heat pump unit may further comprise a heat pump body coupled to a lower side of the temperature management unit. The heat pump body may connect the compressor, the expansion valve, the refrigerant switching valve, and the refrigerant bypass unit. The refrigerant-coolant heat exchanger may be installed on a lower side of the heat pump body, and the compressor may be provided in a structure that extends outward from the heat pump body.

### Advantageous Effects

According to an embodiment of the present invention, a thermal management system for an electric vehicle is configured such that coolant flowing through a coolant circulation passage of a temperature management unit is heated or cooled by refrigerant flowing through a refrigerant circulation passage of a heat pump unit, and the cooled or heated coolant is then circulated to a battery pack, electric component module, and coolant-air heat exchangers of an air-conditioning device.

Accordingly, the system is capable of appropriately managing the temperatures of the battery pack, the electric component module, and the coolant-air heat exchangers using the coolant of the temperature management unit, and may integrally control the temperatures of those components depending on the driving environment of the electric vehicle.

In addition, the thermal management system for an electric vehicle according to the embodiment of the present invention has a structure in which the functions of cabin air-conditioning and temperature control of the battery pack and the electric component module are integrated. Therefore, a conventional heating and cooling system for cabin air-conditioning may be omitted, thereby simplifying the configuration of the thermal management system. As a result, the thermal management system may be manufactured as a single integrated module, and the manufacturing cost, weight, and installation space of the system may be efficiently reduced.

Moreover, the thermal management system for an electric vehicle according to the embodiment of the present invention allows various flow patterns to be set for the coolant circulation passage by controlling the flow of coolant to the battery pack, the electric component module, and the heat exchangers of the air-conditioning device using the coolant control valves of the temperature management unit.

This enables the system to smoothly perform a variety of thermal management modes in response to diverse driving environments and enhances the temperature control performance of the thermal management system.

Additionally, in the thermal management system according to the embodiment of the present invention, the refrigerant switching valve of the heat pump unit enables the flow direction of the refrigerant circulating through the refrigerant circulation passage to be switched between a forward direction and a reverse direction.

As a result, the heat exchange pattern between the refrigerant of the heat pump unit and the coolant of the temperature management unit may vary, making it possible to expand the number of thermal management modes supported by the temperature management unit, and thereby improving the effectiveness of temperature control for the battery pack, the electric component module, and the air-conditioning device.

Furthermore, in the thermal management system according to the embodiment of the present invention, the thermal management modes of the temperature management unit may be further subdivided by appropriately combining: refrigerant valve modes 1 to 3 of the refrigerant switching valve; coolant valve modes 1 to 5 of the first coolant control valve; and coolant valve modes 6 to 9 of the second coolant control valve.

Accordingly, by variably configuring the flow patterns of the refrigerant circulation passage and the coolant circulation passage, the system may smoothly perform various thermal management modes including: cabin heating and cooling, battery pack warm-up, electric component module warm-up, fast charging of the battery pack, defogging, defrosting, dehumidification, and waste heat recovery.

Finally, since the thermal management system for an electric vehicle according to the embodiment of the present invention adopts an integrated structure in which the heat pump unit and the temperature management unit are combined into a single body, the system may be designed with a compact and simplified structure, allowing installation space to be secured more easily.

Compared to a structure in which the heat pump unit and the temperature management unit are separately provided, the integrated structure also eliminates the need for separate components such as hoses or pipes used to connect the two units.

### DESCRIPTION OF DRAWINGS

FIG. 1 is a block diagram illustrating a thermal management system for an electric vehicle according to an embodiment of the present invention.

FIG. 2 is a diagram illustrating an outdoor heat absorption heating mode of the thermal management system shown in FIG. 1.

FIG. 3 is a diagram illustrating an inefficient heating mode of the thermal management system shown in FIG. 1.

FIG. 4 is a diagram illustrating an inefficient heating and drying mode of the thermal management system shown in FIG. 1.

FIG. 5 is a diagram illustrating a waste heat recovery heating mode of the thermal management system shown in FIG. 1.

FIG. 6 is a diagram illustrating an outdoor heat absorption battery warm-up mode of the thermal management system shown in FIG. 1.

FIG. 7 is a diagram illustrating an inefficient battery warm-up mode of the thermal management system shown in FIG. 1.

FIG. 8 is a diagram illustrating an inefficient battery warm-up and drying mode of the thermal management system shown in FIG. 1.

FIG. 9 is a diagram illustrating a battery heat storage mode of the thermal management system shown in FIG. 1.

FIG. 10 is a diagram illustrating a defogging mode of the thermal management system shown in FIG. 1.

FIG. 11 is a diagram illustrating a defrosting mode of the thermal management system shown in FIG. 1.

FIG. 12 is a diagram illustrating a dehumidification mode of the thermal management system shown in FIG. 1.

FIG. 13 is a diagram illustrating a charging cooling mode of the thermal management system shown in FIG. 1.

FIG. 14 is a diagram illustrating a battery cooling air-conditioning mode of the thermal management system shown in FIG. 1.

FIG. 15 is a diagram illustrating an electric component warm-up air-conditioning mode of the thermal management system shown in FIG. 1.

FIG. 16 is a diagram illustrating valve modes of a first coolant control valve corresponding to the thermal management modes of the thermal management system shown in FIGS. 2 to 15.

FIG. 17 is a diagram illustrating valve modes of a second coolant control valve corresponding to the thermal management modes of the thermal management system shown in FIGS. 2 to 15.

FIG. 18 is a diagram illustrating valve modes of a refrigerant switching valve corresponding to the thermal management modes of the thermal management system shown in FIGS. 2 to 15.

FIGS. 19 and 20 are a perspective view and a side view, respectively, illustrating a modeling example of a thermal management system for an electric vehicle according to an embodiment of the present invention.

FIG. 21 is a diagram illustrating a heat pump unit of the thermal management system shown in FIGS. 19 and 20.

FIG. 22 is a diagram illustrating an upper structure of a temperature management unit of the thermal management system shown in FIGS. 19 and 20.

FIG. 23 is a diagram illustrating a lower structure of the temperature management unit of the thermal management system shown in FIGS. 19 and 20.

FIG. 24 is a diagram illustrating an upper body of a valve housing shown in FIG. 22.

FIG. 25 is a diagram illustrating a coolant control valve of the valve housing shown in FIG. 22.

FIG. 26 is a schematic diagram illustrating an installed state of a first coolant control valve shown in FIG. 25.

FIG. 27 is a diagram illustrating a first-1 unit valve body of the first coolant control valve shown in FIG. 26.

FIG. 28 is a diagram illustrating an exploded view of a second coolant control valve shown in FIG. 25.

### BEST MODE

Hereinafter, embodiments of the present invention will be described in detail with reference to the accompanying drawings. However, the present invention is not limited to the embodiments described herein.

Like reference numerals in the drawings denote like components throughout the specification.

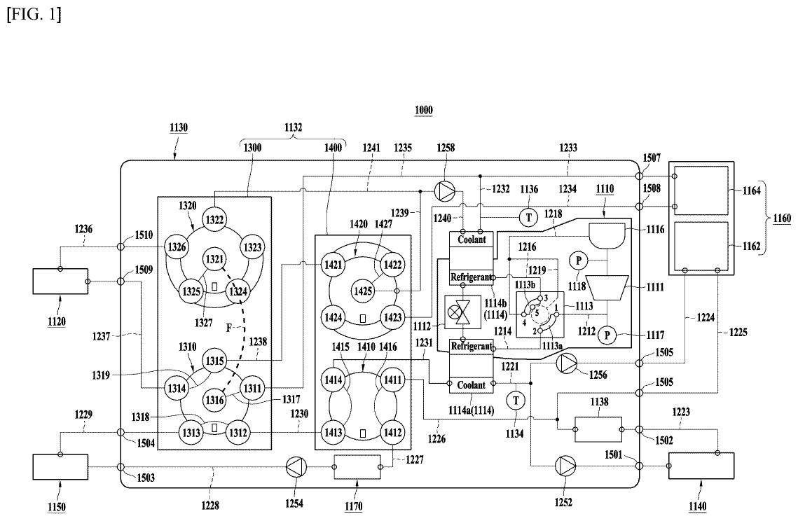

FIG. 1 is a configuration diagram illustrating a thermal management system (1000) for an electric vehicle according to an embodiment of the present invention.

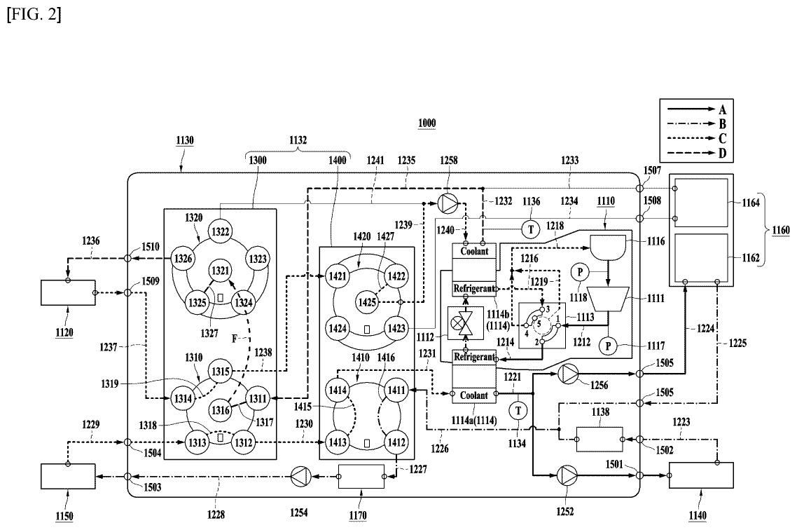

FIGS. 2 to 15 are diagrams respectively illustrating an outdoor heat absorption heating mode, an inefficient heating mode, an inefficient heating and drying mode, a waste heat recovery heating mode, an outdoor heat absorption battery warm-up mode, an inefficient battery warm-up mode, an inefficient battery warm-up and drying mode, a battery heat storage mode, a defogging mode, a defrosting mode, a dehumidification mode, a charging cooling mode, a battery cooling air-conditioning mode, and an electric component warm-up air-conditioning mode of the thermal management system (1000) shown in FIG. 1.

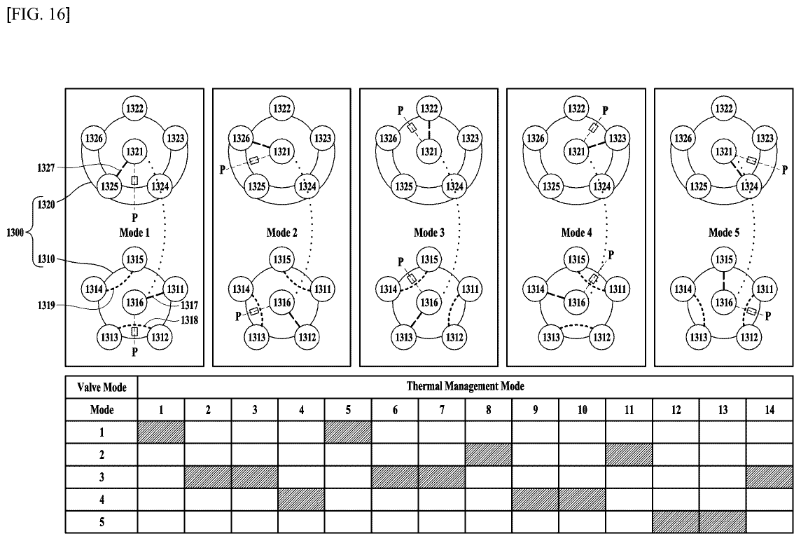

FIG. 16 is a diagram illustrating valve modes of a first coolant control valve (1300) corresponding to the thermal management modes of the thermal management system (1000) shown in FIGS. 2 to 15.

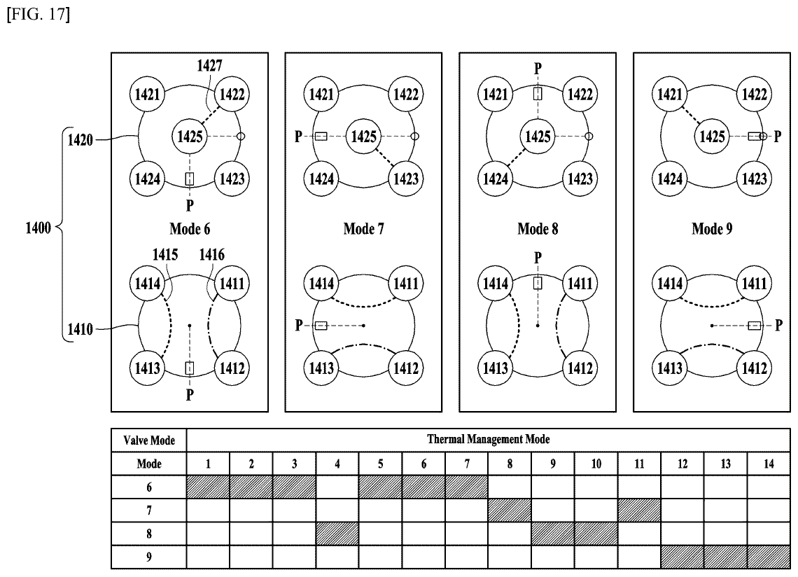

FIG. 17 is a diagram illustrating valve modes of a second coolant control valve (1400) corresponding to the thermal management modes of the thermal management system (1000) shown in FIGS. 2 to 15.

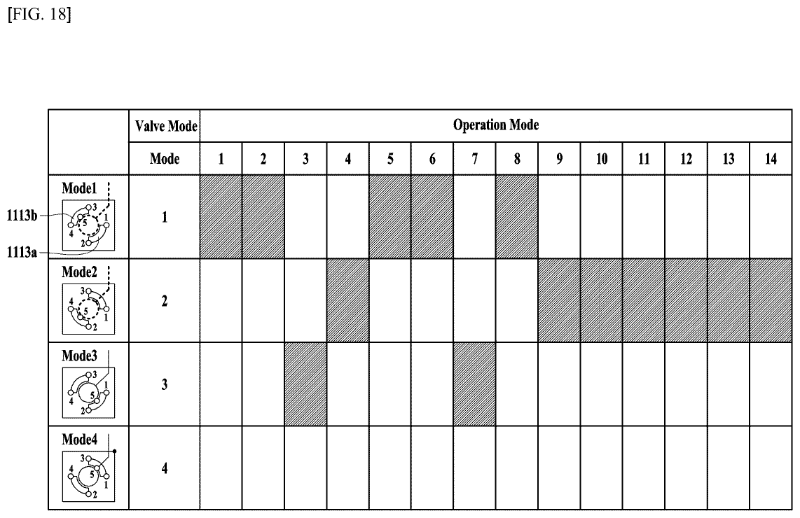

FIG. 18 is a diagram illustrating valve modes of a refrigerant switching valve (1113) corresponding to the thermal management modes of the thermal management system (1000) shown in FIGS. 2 to 15.

Referring to FIG. 1, a thermal management system (1000) for an electric vehicle according to an embodiment of the present invention may comprise a heat pump unit (1110) and a temperature management unit (1130).

The thermal management system (1000) according to the present embodiment may be implemented as a single integrated module in which the heat pump unit (1110) and the temperature management unit (1130) are combined, and the operation of the heat pump unit (1110) and the temperature management unit (1130) may be integrally controlled.

In addition, the heat pump unit (1110) of the present embodiment circulates refrigerant along refrigerant circulation passages (1212, 1214, 1216, 1218), which may be implemented using refrigerant pipes.

In contrast, the temperature management unit (1130) circulates coolant along coolant circulation passages (1221 to 1241), which may be implemented using coolant hoses.

Particularly, since the coolant circulation passages (1221 to 1241) in the present embodiment are formed using coolant hoses, the passages may be manufactured at low cost and easily bent, thereby improving both design flexibility and installation convenience of the temperature management unit (1130).

Although the thermal management system (1000) in the present embodiment is described as being applied to an electric vehicle, it is not limited thereto, and may also be applied to other types of vehicles or equipment equipped with a battery pack (1140), electric component module (1150), and a coolant-air heat exchanger (1160) for an air-conditioning device—for example, to mobile platforms such as drone-type flying vehicles or electric motor boats, or to machinery such as excavators, combine harvesters, and other working machines.

In the present embodiment, the battery pack (1140) may include a water-cooled heat sink that allows the battery pack to be cooled by coolant in a liquid cooling manner.

The electric component module (1150) may include a motor that provides propulsion to the electric vehicle and a controller that governs its operation, and may also include a water-cooled condenser through which coolant flows.

The coolant-air heat exchanger (1160) of the air-conditioning device may be disposed within the cabin of the electric vehicle to perform cabin air-conditioning, dehumidification, defogging, and defrosting functions, and may be installed in close proximity as a pair of exchangers within the cabin interior.

With reference to FIGS. 1 to 15 and FIG. 18, the configuration and operation modes of the heat pump unit (1110) according to the present embodiment will now be described in detail.

As shown in FIGS. 1 to 15 and FIG. 18, the heat pump unit (1110) of the present embodiment may define refrigerant circulation passages (1212, 1214, 1216, 1218), through which refrigerant flows and heat is emitted or absorbed according to heat of condensation and sensible heat of the refrigerant.

The heat pump unit (1110) may function as a heating and cooling system that transfers heat from a low-temperature heat source to a high-temperature environment or vice versa by utilizing the condensation heat or sensible heat of the refrigerant.

For example, the heat pump unit (1110) may comprise a compressor (1111), an expansion valve (1112), a refrigerant switching valve (1113), a refrigerant-coolant heat exchanger (1114), and a refrigerant bypass unit (5, 1219).

As shown in FIGS. 1 to 15, the compressor (1111) may be disposed at one side of the refrigerant circulation passages (1212, 1214, 1216, 1218) to compress the refrigerant to a high temperature.

The expansion valve (1112) may be disposed at the other side of the refrigerant circulation passages to expand the refrigerant to a low temperature.

The refrigerant switching valve (1113) may be positioned between the compressor (1111) and the expansion valve (1112) along the refrigerant circulation passages (1212, 1214, 1216, 1218) to switch the flow direction of the refrigerant circulating therein.

The refrigerant-coolant heat exchanger (1114) may be disposed upstream and downstream of the expansion valve (1112) along the refrigerant circulation passages (1212, 1214, 1216, 1218), so as to exchange heat between the refrigerant and the coolant flowing through the temperature management unit (1130), described below.

As shown in FIG. 1, the refrigerant circulation passages (1212, 1214, 1216, 1218) may comprise:

a first refrigerant passage (1212) connecting an outlet of the compressor (1111) to a first refrigerant port (1) of the refrigerant switching valve (1113);

a second refrigerant passage (1214) connecting a second refrigerant port (2) of the refrigerant switching valve (1113) to a first port of the expansion valve (1112);

a third refrigerant passage (1216) connecting a second port of the expansion valve (1112) to a third refrigerant port (3) of the refrigerant switching valve (1113); and

a fourth refrigerant passage (1218) connecting a fourth refrigerant port (4) of the refrigerant switching valve (1113) to an inlet of the compressor (1111).

As shown in FIGS. 1 to 15, the expansion valve (1112) may expand the refrigerant, thereby reducing the temperature and pressure of the refrigerant.

The expansion valve (1112) may be implemented as a two-way expansion valve having two ports through which the refrigerant flows in and out.

The ports of the expansion valve (1112) may include a first port connected to the second refrigerant passage (1214) and a second port connected to the third refrigerant passage (1216).

As shown in FIGS. 1 to 15 and FIG. 18, the refrigerant switching valve (1113) may be configured to switch the flow direction of the refrigerant circulating through the refrigerant circulation passages (1212, 1214, 1216, 1218).

The refrigerant switching valve (1113) may be located between the compressor (1111) and the expansion valve (1112), and may be arranged along the refrigerant circulation passages.

The refrigerant switching valve (1113) may be implemented as a four-way switching valve having a first refrigerant port (1), a second refrigerant port (2), a third refrigerant port (3), and a fourth refrigerant port (4).

Here, one end of the first refrigerant passage (1212) may be connected in fluid communication with the first refrigerant port (1),

one end of the second refrigerant passage (1214) may be connected in fluid communication with the second refrigerant port (2),

one end of the third refrigerant passage (1216) may be connected in fluid communication with the third refrigerant port (3), and

one end of the fourth refrigerant passage (1218) may be connected in fluid communication with the fourth refrigerant port (4).

Additionally, inside the refrigerant switching valve (1113), two internal valve passages for refrigerant may be formed in correspondence with each other and rotated according to the valve mode of the refrigerant switching valve (1113).

As shown in FIG. 1, the refrigerant switching valve (1113) may include a first refrigerant valve passage (1113a) and a second refrigerant valve passage (1113b).

The first refrigerant valve passage (1113a) may be configured to connect two adjacent refrigerant ports among the first, second, third, and fourth refrigerant ports (1, 2, 3, and 4).

The second refrigerant valve passage (1113b) may be configured to connect the other two refrigerant ports, not connected by the first refrigerant valve passage (1113a), among the first to fourth refrigerant ports.

For example, the first refrigerant valve passage (1113a) may connect the first refrigerant port (1) and the second refrigerant port (2), or the third refrigerant port (3) and the fourth refrigerant port (4), or the first refrigerant port (1) and the third refrigerant port (3), depending on the rotational angle of the refrigerant switching valve (1113).

Likewise, the second refrigerant valve passage (1113b) may connect the first refrigerant port (1) and the second refrigerant port (2), the third refrigerant port (3) and the fourth refrigerant port (4), or the second refrigerant port (2) and the fourth refrigerant port (4), depending on the rotational angle of the refrigerant switching valve (1113).

As shown in FIG. 18, the refrigerant switching valve (1113) may operate in any one of a first refrigerant valve mode, a second refrigerant valve mode, or a third refrigerant valve mode according to its rotational angle.

In a first refrigerant valve mode, the first refrigerant valve passage (1113a) may connect the first refrigerant port (1) and the second refrigerant port (2), and the second refrigerant valve passage (1113b) may connect the third refrigerant port (3) and the fourth refrigerant port (4).

In this mode, a portion of the refrigerant introduced into the third refrigerant port (3) may be bypassed to the fourth refrigerant passage (1218) through the refrigerant bypass unit (5, 1219).

Specifically, in the first refrigerant valve mode, the first refrigerant port (1) and the second refrigerant port (2) are connected through the first refrigerant valve passage (1113a), so that the first refrigerant passage (1212) is fluidly connected to the second refrigerant passage (1214).

Similarly, the third refrigerant port (3) and the fourth refrigerant port (4) are connected through the second refrigerant valve passage (1113b), so that the third refrigerant passage (1216) is fluidly connected to the fourth refrigerant passage (1218).

In a second refrigerant valve mode, the first refrigerant valve passage (1113a) may connect the first refrigerant port (1) and the third refrigerant port (3), and the second refrigerant valve passage (1113b) may connect the second refrigerant port (2) and the fourth refrigerant port (4).

In this mode, a portion of the refrigerant introduced into the second refrigerant port (2) may be bypassed to the fourth refrigerant passage (1218) through the refrigerant bypass unit (5, 1219).

Specifically, in the second refrigerant valve mode, the first refrigerant port (1) and the third refrigerant port (3) are connected through the first refrigerant valve passage (1113a), so that the first refrigerant passage (1212) is fluidly connected to the third refrigerant passage (1216).

Likewise, the second refrigerant port (2) and the fourth refrigerant port (4) are connected through the second refrigerant valve passage (1113b), so that the second refrigerant passage (1214) is fluidly connected to the fourth refrigerant passage (1218).

In a third refrigerant valve mode, the first refrigerant valve passage (1113a) may connect the third refrigerant port (3) and the fourth refrigerant port (4), and the second refrigerant valve passage (1113b) may connect the first refrigerant port (1) and the second refrigerant port (2).

In this mode, a portion of the refrigerant introduced into the first refrigerant port (1) may be bypassed to the fourth refrigerant passage (1218) through the refrigerant bypass unit (5, 1219).

Specifically, in the third refrigerant valve mode, the third refrigerant port (3) and the fourth refrigerant port (4) are connected through the first refrigerant valve passage (1113a), so that the third refrigerant passage (1216) is fluidly connected to the fourth refrigerant passage (1218).

Likewise, the first refrigerant port (1) and the second refrigerant port (2) are connected through the second refrigerant valve passage (1113b), so that the first refrigerant passage (1212) is fluidly connected to the second refrigerant passage (1214).

Meanwhile, in the first and second refrigerant valve modes, a portion of the refrigerant introduced into the second refrigerant valve passage (1113b) may flow into the fourth refrigerant passage (1218) through the refrigerant bypass unit (5, 1219), and the remaining portion of the refrigerant may also flow directly into the fourth refrigerant passage (1218).

Accordingly, the refrigerant bypassed by the refrigerant bypass unit (5, 1219) corresponds to a portion of the refrigerant flowing from the fourth refrigerant port (4) to the fourth refrigerant passage (1218), and the refrigerant bypassed via the refrigerant bypass unit and the refrigerant discharged from the fourth refrigerant port (4) may merge at the same temperature and flow together toward the inlet of the compressor (1111).

In contrast, in the third refrigerant valve mode, a portion of the refrigerant introduced into the first refrigerant valve passage (1113a) may flow to the fourth refrigerant passage (1218) via the refrigerant bypass unit (5, 1219), and the refrigerant introduced into the third refrigerant passage (1216) may newly flow into the fourth refrigerant passage (1218).

Accordingly, since the refrigerant bypassed through the refrigerant bypass unit (5, 1219) originates from the third refrigerant passage (1216), which is different from the refrigerant flowing from the fourth refrigerant port (4) to the fourth refrigerant passage (1218), the refrigerant bypassed by the refrigerant bypass unit and the refrigerant discharged from the fourth refrigerant port (4) may merge at different temperatures before flowing into the inlet of the compressor (1111).

As shown in FIGS. 1 to 15, the refrigerant-coolant heat exchanger (1114) may comprise:

a first refrigerant-coolant heat exchanger (1114a) thermally coupled to the second refrigerant passage (1214), and

a second refrigerant-coolant heat exchanger (1114b) thermally coupled to the third refrigerant passage (1216).

For example, the first and second refrigerant-coolant heat exchangers (1114a, 1114b) may be implemented as plate-type heat exchangers.

Here, one side of the first refrigerant-coolant heat exchanger (1114a) may be thermally connected to the second refrigerant passage (1214), and the other side may be thermally connected to a first coolant passage (1221) and an eleventh coolant passage (1231) among the coolant circulation passages (1221 to 1241), which will be described later.

When the refrigerant switching valve (1113) operates in the first or third refrigerant valve mode, the first refrigerant-coolant heat exchanger (1114a) may heat the coolant introduced through the eleventh coolant passage (1231) using high-temperature refrigerant flowing through the second refrigerant passage (1214), and discharge the heated coolant to the first coolant passage (1221).

Conversely, when the refrigerant switching valve (1113) operates in the second refrigerant valve mode, the first refrigerant-coolant heat exchanger (1114a) may cool the coolant introduced through the eleventh coolant passage (1231) using low-temperature refrigerant flowing through the second refrigerant passage (1214), and discharge the cooled coolant to the first coolant passage (1221).

In addition, one side of the second refrigerant-coolant heat exchanger (1114b) may be thermally connected to the third refrigerant passage (1216), and the other side may be thermally connected to a twelfth coolant passage (1232) and a twentieth coolant passage (1240) among the coolant circulation passages (1221 to 1241), as will be described below.

When the refrigerant switching valve (1113) operates in the first or third refrigerant valve mode, the second refrigerant-coolant heat exchanger (1114b) may cool the coolant introduced through the twentieth coolant passage (1240) using low-temperature refrigerant flowing through the third refrigerant passage (1216), and discharge the cooled coolant to the twelfth coolant passage (1232).

In addition, when the refrigerant switching valve (1113) operates in the second refrigerant valve mode, the second refrigerant-coolant heat exchanger (1114b) may heat the coolant introduced through the twentieth coolant passage (1240) using high-temperature refrigerant flowing through the third refrigerant passage (1216), and discharge the heated coolant to the twelfth coolant passage (1232).

As shown in FIGS. 1 to 15 and FIG. 18, the refrigerant bypass unit (5, 1219) may be configured to bypass a portion of the refrigerant introduced into the refrigerant switching valve (1113) to the fourth refrigerant passage (1218) connected to the inlet of the compressor (1111).

To achieve this, the refrigerant bypass unit (5, 1219) may be provided at the refrigerant switching valve (1113) and the refrigerant circulation passages (1212, 1214, 1216, 1218).

For example, the refrigerant bypass unit (5, 1219) may include a fifth refrigerant port (5) and a bypass passage (1219).

The fifth refrigerant port (5) may be formed in the second refrigerant valve flow path (1113b) of the refrigerant switching valve (1113) and may rotate together with the second refrigerant valve flow path (1113b).

One end of the bypass passage (1219) may be connected to the refrigerant switching valve (1113) so as to be constantly connected to the fifth refrigerant port (5), and the other end of the bypass passage (1219) may be connected to the fourth refrigerant passage (1218).

Accordingly, a portion of the refrigerant flowing through the second refrigerant valve flow path (1113b) may be continuously bypassed to the fourth refrigerant passage (1218) via the fifth refrigerant port (5) and the bypass passage (1219).

As shown in FIG. 1, the heat pump unit (1110) of the present embodiment may further include: an accumulator (1116) configured to maintain the pressure of the refrigerant introduced into the inlet of the compressor (1111) constant and communicatively disposed on the fourth refrigerant passage (1218), a first pressure sensor (1117) disposed on the first refrigerant passage (1212) and configured to measure the pressure of the refrigerant discharged from the outlet of the compressor (1111), and a second pressure sensor (1118) disposed on the fourth refrigerant passage (1218) and configured to measure the pressure of the refrigerant introduced into the inlet of the compressor (1111).

The accumulator (1116) may be disposed in communication with the fourth refrigerant passage (1218) so as to be located adjacent to the inlet of the compressor (1111).

Further, the temperature management system (1000) of the electric vehicle may appropriately control the operation of the compressor (1111) using the measurement results from the first pressure sensor (1117) and the second pressure sensor (1118).

The configuration and operation modes of the temperature management unit (1130) of the present embodiment will now be described in detail with reference to FIGS. 1 through 17.

Referring to FIGS. 1 through 17, the temperature management unit (1130) of the present embodiment may be configured to control the temperatures of a battery pack (1140), an electronic component module (1150), and a coolant-to-air heat exchanger (1160) using coolant that has undergone heat exchange via the heat pump unit (1110) and a radiator (1120) to be described later.

To this end, the temperature management unit (1130) may include coolant circulation passages (1221 through 1241) configured to supply coolant of various temperatures to the battery pack (1140), the electronic component module (1150), and the coolant-to-air heat exchanger (1160).

At this time, by changing the flow pattern of the coolant circulation passages (1221 through 1241), the temperature management unit (1130) may control whether to supply coolant to the battery pack (1140), the electronic component module (1150), and the coolant-to-air heat exchanger (1160), as well as adjust the temperature of the coolant being supplied.

The coolant of the temperature management unit (1130), as described above, may be heated or cooled through the first refrigerant-to-coolant heat exchanger (1114a) and the second refrigerant-to-coolant heat exchanger (1114b) of the heat pump unit (1110).

In other words, the heat pump unit (1110) is used as a heat source for the temperature management unit (1130), which controls the temperatures of the battery pack (1140), the electronic component module (1150), and the coolant-to-air heat exchanger (1160).

For example, the temperature management unit (1130) may include a radiator (1120), a coolant control valve (1132), a first temperature sensor (1134), a second temperature sensor (1136), and a coolant heater (1138).

As illustrated in FIGS. 1 through 15, the radiator (1120) may be configured to heat or cool the coolant flowing through the coolant circulation passages (1221 through 1241) by exchanging heat with ambient air. Here, the radiator (1120) may be connected to a first coolant control valve (1300) of a coolant control valve (1132), which will be described later, via a sixteenth coolant passage (1236) and a seventeenth coolant passage (1237) included in the coolant circulation passages (1221 through 1241) to be described below.

The radiator (1120), as described above, may be fabricated separately from conventional radiators used in electric vehicles and may be individually installed in the temperature management unit (1130). However, in the present embodiment, the radiator (1120) is not additionally installed in the temperature management unit (1130); instead, an existing radiator is shared. Accordingly, since the radiator conventionally used in electric vehicles is also utilized in the temperature management unit (1130), the implementation of component sharing may provide advantages in terms of cost reduction of the temperature management system (1000) and securing installation space. In practice, the temperature management unit (1130) may be easily connected to the existing radiator using coolant hoses.

As shown in FIGS. 1 through 17, the coolant control valve (1132) may operate in any one of a plurality of coolant valve modes that change the flow pattern of the coolant circulation passages (1221 through 1241). To this end, the coolant control valve (1132) may be disposed on the coolant circulation passages (1221 through 1241).

As described above, the coolant control valve (1132) may control the temperatures of the battery pack (1140), the power electronic module (1150), and the coolant-to-air heat exchanger (1160) by varying the coolant flow patterns through switching between a plurality of coolant valve modes. The coolant valve modes of the coolant control valve (1132) may be preconfigured in multiple patterns to control the temperatures of the battery pack (1140), the power electronic module (1150), and the coolant-to-air heat exchanger (1160) based on the driving environment of the electric vehicle and user preferences.

For example, the coolant control valve (1132) according to the present embodiment may include a first coolant control valve (1300) and a second coolant control valve (1400).

Here, the first coolant control valve (1300) may include a pair of unit valves (1310, 1320), each having five external ports (1311 through 1315, and 1322 through 1326) spaced apart at predetermined intervals along the perimeter of the outer edge. At least one of the five external ports (1311 through 1315, and 1322 through 1326) may be selectively opened or closed according to the rotation angle.

The external ports (1311 through 1315, and 1322 through 1326) of the first coolant control valve (1300), as described above, may be connected via the coolant circulation passages (1221 through 1241) to at least one of the following: the radiator (1120), the power electronic module (1150), the first coolant-to-air heat exchanger (1162), the second refrigerant-to-coolant heat exchanger (1114b), and the external ports (1411 through 1414, and 1421 through 1424) of the second coolant control valve (1400).

Meanwhile, the second coolant control valve (1400) may include a pair of unit valves (1410, 1420), each having four external ports (1411 through 1414, and 1421 through 1424) spaced apart at predetermined intervals along the perimeter of the outer edge. At least one of the four external ports (1411 through 1414, and 1421 through 1424) may be selectively opened or closed according to the rotation angle.

The external ports (1411 through 1414, and 1421 through 1424) of the second coolant control valve (1400), as described above, may be connected via the coolant circulation passages (1221 through 1241) to at least one of the following: the power electronic module (1150), the first coolant-to-air heat exchanger (1162), the second coolant-to-air heat exchanger (1164), the first refrigerant-to-coolant heat exchanger (1114a), the second refrigerant-to-coolant heat exchanger (1114b), the battery pack (1140), and the external ports (1311 through 1315, and 1322 through 1326) of the second coolant control valve (1400).

As shown in FIGS. 1 to 15, a first temperature sensor (1134) may be disposed on a first coolant passage (1221), which will be described later, to measure in real time the temperature of the coolant flowing along the first coolant passage (1221). Specifically, the first temperature sensor (1134) may measure the temperature of the coolant that has exchanged heat with the refrigerant in the first refrigerant-to-coolant heat exchanger (1114a).

As shown in FIGS. 1 to 15, a second temperature sensor (1136) may be disposed on a second coolant passage (1222) to measure in real time the temperature of the coolant flowing along the twelfth coolant passage (1232), which will be described later. Specifically, the second temperature sensor (1136) may measure the temperature of the coolant that has exchanged heat with the refrigerant in the second refrigerant-to-coolant heat exchanger (1114b).

As shown in FIGS. 1 to 15, a coolant heater (1138) is a heating device for reheating the coolant that has been used for temperature control of the battery pack (1140). Accordingly, the coolant heater (1138) may be disposed on a third coolant passage (1223), which will be described later, to heat the coolant flowing from the battery pack (1140) toward a thirteenth coolant port (1411) of the coolant control valve (1132).

Hereinafter, the structure of the first coolant control valve (1300) and the second coolant control valve (1400) according to the present embodiment will be described in detail with reference to FIGS. 1 to 15.

As shown in FIGS. 1 to 15, the first coolant control valve (1300) of the present embodiment may include a first unit valve (1310) and a second unit valve (1320) that rotate together along a common rotation center.

Here, on the outer side of the first unit valve (1310), a first coolant port (1311) connected to the second refrigerant-coolant heat exchanger (1114b) and the second coolant-air heat exchanger (1164), a second coolant port (1312) connected to one side of the second coolant control valve (1400), a third coolant port (1313) connected to the electric component module (1150), a fourth coolant port (1314) connected to the radiator (1120), and a fifth coolant port (1315) connected to the other side of the second coolant control valve (1400) may be circumferentially arranged at predetermined angular intervals.

A sixth coolant port (1316) may be disposed at the rotational center of the first unit valve (1310). The sixth coolant port (1316) may be connected to one side of a connection passage (F) formed to connect the rotational centers of the first unit valve (1310) and the second unit valve (1320).

Inside the first unit valve (1310), a first internal coolant valve passage (1317) may be formed to connect the sixth coolant port (1316) to any one of the first to fifth coolant ports (1311 to 1315) according to the rotation angle of the first unit valve (1310). A second internal coolant valve passage (1318) may be formed to connect two of the first to fifth coolant ports (1311 to 1315) that are spaced apart in the clockwise direction from the first internal coolant valve passage (1317), and a third internal coolant valve passage (1319) may be formed to connect two of the first to fifth coolant ports that are spaced apart in the counterclockwise direction from the second internal coolant valve passage (1318).

On the outer side of the second unit valve (1320), an eighth coolant port (1322) connected to the second refrigerant-coolant heat exchanger (1114b) and ninth to twelfth coolant ports (1323 to 1326) connected to the radiator (1120) may be circumferentially arranged at predetermined angular intervals.

At the rotational center of the second unit valve (1320), a seventh coolant port (1321) connected to the sixth coolant port (1316) may be disposed. The seventh coolant port (1321) may be connected to the sixth coolant port (1316) through a connection passage (F).

Inside the second unit valve (1320), a fourth internal coolant valve passage (1327) may be formed to connect the seventh coolant port (1321) to any one of the eighth to twelfth coolant ports (1322 to 1326) depending on the rotation angle of the second unit valve (1320).

As shown in FIGS. 1 to 15, the second coolant control valve (1400) of the present embodiment may include a third unit valve (1410) and a fourth unit valve (1420), which rotate together along a common rotation center.

Here, on the outer side of the third unit valve (1410), a thirteenth coolant port (1411) connected to the first refrigerant-coolant heat exchanger (1114a) and the battery pack (1140), a fourteenth coolant port (1412) connected to the electric component module (1150), a fifteenth coolant port (1413) connected to the second coolant port (1312), and a sixteenth coolant port (1414) connected to the first refrigerant-coolant heat exchanger (1114a) may be circumferentially arranged at predetermined angular intervals.

Inside the third unit valve (1410), a fifth internal coolant valve passage (1415) may be formed to connect two adjacent ports among the thirteenth to sixteenth coolant ports (1411 to 1414), and a sixth internal coolant valve passage (1416) may be formed to connect another pair of adjacent ports among the thirteenth to sixteenth coolant ports.

On the outer side of the fourth unit valve (1420), seventeenth and eighteenth coolant ports (1421, 1422) connected to the fifth coolant port (1315), and nineteenth and twentieth coolant ports (1423, 1424) connected to the second coolant-air heat exchanger (1164) may be circumferentially arranged at predetermined angular intervals.

At the rotational center of the fourth unit valve (1420), a twenty-first coolant port (1425) connected to the second refrigerant-coolant heat exchanger (1114b) may be disposed.

Inside the fourth unit valve (1420), a seventh internal coolant valve passage (1427) may be formed to connect the twenty-first coolant port (1425) to any one of the seventeenth to twentieth coolant ports (1421 to 1424) according to the rotation angle of the fourth unit valve (1420).

As described above, the coolant control valve (1132) of the present embodiment is configured as a combined structure including a first coolant control valve (1300) comprising a first unit valve (1310) and a second unit valve (1320), and a second coolant control valve (1400) comprising a third unit valve (1410) and a fourth unit valve (1420). However, the configuration is not limited thereto and may be variously modified into other valve structures for changing the flow pattern of the coolant circulation passages (1221 to 1241).

For example, the first coolant control valve (1300) may be configured as a stacked structure of the first unit valve (1310) and the second unit valve (1320), and the second coolant control valve (1400) may be configured as a stacked structure of the third unit valve (1410) and the fourth unit valve (1420).

Since the coolant control valve (1132) may integrate the first unit valve (1310), the second unit valve (1320), the third unit valve (1410), and the fourth unit valve (1420) into a single component, the coolant control valve (1132) provides significant advantages in terms of component miniaturization, reduction in manufacturing cost, design flexibility, and securing installation space.

As illustrated in FIGS. 1 to 15, coolant circulation passages (1221 to 1241) connected to the coolant control valve (1132) and the refrigerant-coolant heat exchangers (1114) of the heat pump unit (1110) are shown.

As illustrated in FIGS. 1 to 15, the coolant circulation passages (1221 to 1241) may include: a first coolant passage (1221) connected to the first refrigerant-coolant heat exchanger (1114a) and configured to guide coolant heat-exchanged at the first refrigerant-coolant heat exchanger (1114a), a second coolant passage (1222) connected to the first coolant passage (1221) and to the battery pack (1140), and configured to guide the coolant from the first coolant passage (1221) to the battery pack (1140), a third coolant passage (1223) connected to the battery pack (1140) and configured to guide coolant heat-exchanged with the battery pack (1140), a fourth coolant passage (1224) connected to the first coolant passage (1221) and to the first coolant-air heat exchanger (1162), and configured to guide the coolant from the first coolant passage (1221) to the first coolant-air heat exchanger (1162), a fifth coolant passage (1225) connected to the first coolant-air heat exchanger (1162) and configured to guide coolant heat-exchanged at the first coolant-air heat exchanger (1162), a sixth coolant passage (1226) connected to the third and fifth coolant passages (1223, 1225) and to a thirteenth coolant port (1411), and configured to guide the coolant from the third and fifth coolant passages (1223, 1225) to the thirteenth coolant port (1411), a seventh coolant passage (1227) connected to a fourteenth coolant port (1412) and to a reservoir (1170), and configured to guide the coolant from the fourteenth coolant port (1412) to the reservoir (1170), an eighth coolant passage (1228) connected to the reservoir (1170) and to the electric component module (1150), and configured to guide the coolant from the reservoir (1170) to the electric component module (1150), a ninth coolant passage (1229) connected to the electric component module (1150) and to a third coolant port (1313), and configured to guide the coolant from the electric component module (1150) to the third coolant port (1313), a tenth coolant passage (1230) connected to a second coolant port (1312) and a fifteenth coolant port (1413), and configured to guide the coolant from the second coolant port (1312) to the fifteenth coolant port (1413), an eleventh coolant passage (1231) connected to a sixteenth coolant port (1414) and to the first refrigerant-coolant heat exchanger (1114a), and configured to guide the coolant from the sixteenth coolant port (1414) to the first refrigerant-coolant heat exchanger (1114a), a twelfth coolant passage (1232) connected to the second refrigerant-coolant heat exchanger (1114b) and configured to guide coolant heat-exchanged at the second refrigerant-coolant heat exchanger (1114b), a thirteenth coolant passage (1233) connected to the twelfth coolant passage (1232) and to the second coolant-air heat exchanger (1164), and configured to guide the coolant from the twelfth coolant passage (1232) to the second coolant-air heat exchanger (1164), a fourteenth coolant passage (1234) connected to the second coolant-air heat exchanger (1164) and to a nineteenth coolant port (1423), and configured to guide the coolant from the second coolant-air heat exchanger (1164) to the nineteenth coolant port (1423), a fifteenth coolant passage (1235) connected to the twelfth coolant passage (1232) and to a first coolant port (1311), and configured to guide the coolant from the twelfth coolant passage (1232) to the first coolant port (1311), a sixteenth coolant passage (1236) connected to a twelfth coolant port (1326) and to a radiator (1120), and configured to guide the coolant between the twelfth coolant port (1326) and the radiator (1120), a seventeenth coolant passage (1237) connected to a fourth coolant port (1314) and to the radiator (1120), and configured to guide the coolant between the fourth coolant port (1314) and the radiator (1120), an eighteenth coolant passage (1238) connected to a fifth coolant port (1315) and a seventeenth coolant port (1421), and configured to guide the coolant from the fifth coolant port (1315) to the seventeenth coolant port (1421), a nineteenth coolant passage (1239) connected to a twenty-first coolant port (1425), and configured to guide the coolant from the twenty-first coolant port (1425), a twentieth coolant passage (1240) connected to the nineteenth coolant passage (1239) and to the second refrigerant-coolant heat exchanger (1114b), and configured to guide the coolant from the nineteenth coolant passage (1239) to the second refrigerant-coolant heat exchanger (1114b), and a twenty-first coolant passage (1241) connected to an eighth coolant port (1322) and to the nineteenth coolant passage (1239), and configured to guide the coolant from the eighth coolant port (1322) to the nineteenth coolant passage (1239).

As shown in FIG. 1, at least one of the first to twenty-first coolant lines (1221˜1241) may be provided with a coolant pump (1252, 1254, 1256, 1258) configured to pump coolant in a desired direction at a predetermined pressure. In the present embodiment, it is described that one coolant pump (1252, 1254, 1256, 1258) is respectively installed in the twentieth coolant line (1240), the second coolant line (1222), the third coolant line (1228), and the fourth coolant line (1224), but the present invention is not limited thereto. The installation positions and the number of the coolant pumps (1252, 1254, 1256, 1258) may be variously modified according to the design conditions of the thermal management unit (1130) and the flow patterns of the coolant circulation lines (1221˜1241).

For example, the coolant pumps (1252, 1254, 1256, 1258) may include a first coolant pump (1252) installed in the second coolant line (1222) to pump coolant from the second refrigerant-coolant heat exchanger (1114b) to the coolant control valve (1132), a second coolant pump (1254) installed in the second coolant line (1222) to pump coolant from the coolant control valve (1132) to the battery pack (1140), a third coolant pump (1256) installed in the third coolant line (1228) to pump coolant from the coolant control valve (1132) to the electrical component module (1150), and a fourth coolant pump (1258) installed in the fourth coolant line (1224) to pump coolant from the coolant control valve (1132) to the first coolant-air heat exchanger (1162).

Hereinafter, the coolant valve modes of the first coolant control valve (1300) and the second coolant control valve (1400) will be described in detail with reference to the drawings shown in FIGS. 1 to 17.

Referring to FIGS. 1 to 16, the first coolant control valve (1300) of the present embodiment may operate in one of a first coolant valve mode, a second coolant valve mode, a third coolant valve mode, a fourth coolant valve mode, or a fifth coolant valve mode. At this time, the first-1 unit valve (1310) and the first-2 unit valve (1320) of the first coolant control valve (1300) may be rotated together by a preset rotation angle (for example, 72 degrees), and the coolant valve modes 1 through 5 may be selectively switched.

As shown in FIGS. 2, 6, and 16, in the first coolant valve mode, the first coolant port (1311) and the sixth coolant port (1316) of the first-1 unit valve (1310) may be connected by the first internal flow path (1317) of the coolant valve, the second coolant port (1312) and the third coolant port (1313) of the first-1 unit valve (1310) may be connected by the second internal flow path (1318) of the coolant valve, the fourth coolant port (1314) and the fifth coolant port (1315) of the first-1 unit valve (1310) may be connected by the third internal flow path (1319) of the coolant valve, and the seventh coolant port (1321) and the eleventh coolant port (1325) of the first-2 unit valve (1320) may be connected by the fourth internal flow path (1327) of the coolant valve.

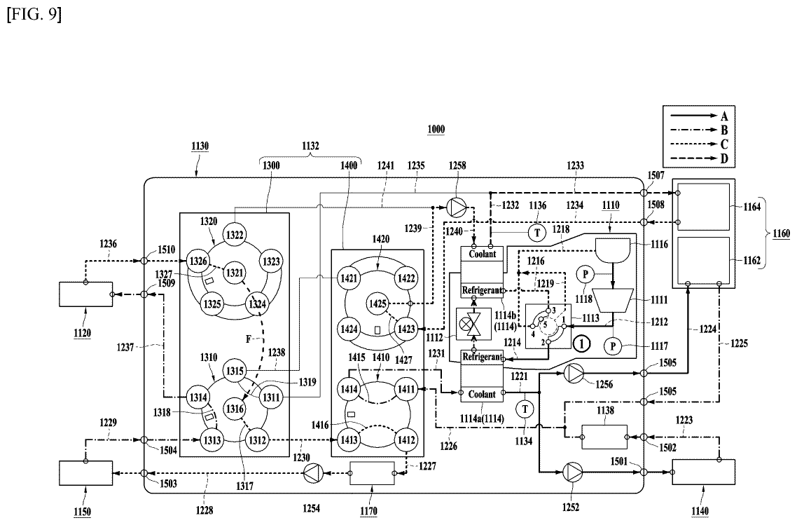

As shown in FIGS. 9, 12, and 16, in the second coolant valve mode, the second coolant port (1312) and the sixth coolant port (1316) of the first-1 unit valve (1310) may be connected by the first internal flow path (1317) of the coolant valve, the third coolant port (1313) and the fourth coolant port (1314) of the first-1 unit valve (1310) may be connected by the second internal flow path (1318) of the coolant valve, the first coolant port (1311) and the fifth coolant port (1315) of the first-1 unit valve (1310) may be connected by the third internal flow path (1319) of the coolant valve, and the seventh coolant port (1321) and the twelfth coolant port (1326) of the first-2 unit valve (1320) may be connected by the fourth internal flow path (1327) of the coolant valve.

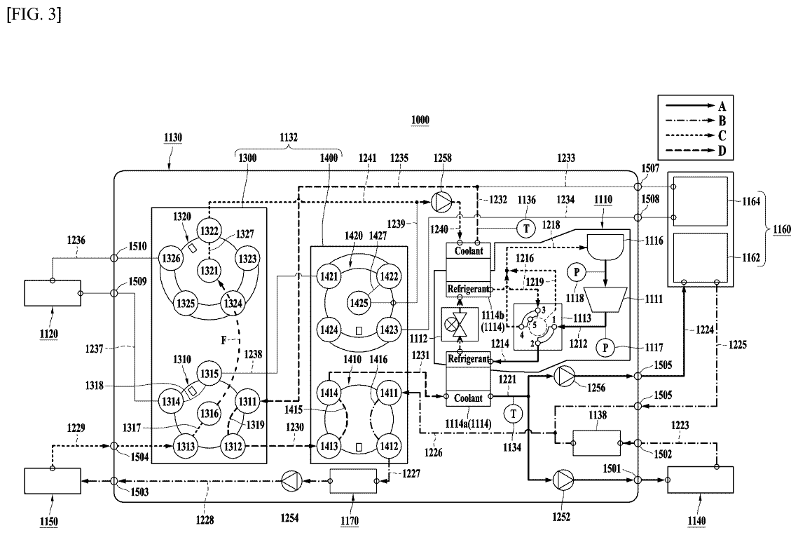

As shown in FIGS. 3, 4, 7, 8, 15, and 16, in the third coolant valve mode, the third coolant port (1313) and the sixth coolant port (1316) of the first-1 unit valve (1310) may be connected by the first internal coolant valve passage (1317); the fourth coolant port (1314) and the fifth coolant port (1315) of the first-1 unit valve (1310) may be connected by the second internal coolant valve passage (1318); the first coolant port (1311) and the second coolant port (1312) of the first-1 unit valve (1310) may be connected by the third internal coolant valve passage (1319); and the seventh coolant port (1321) and the eighth coolant port (1322) of the first-2 unit valve (1320) may be connected by the fourth internal coolant valve passage (1327).

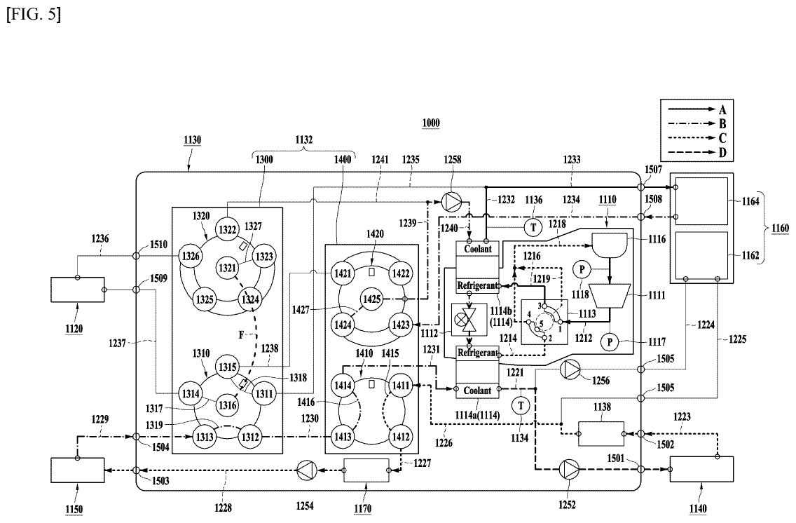

As shown in FIGS. 5, 10, 11, and 16, in the fourth coolant valve mode, the fourth coolant port (1314) and the sixth coolant port (1316) of the first-1 unit valve (1310) may be connected by the first internal coolant valve passage (1317); the first coolant port (1311) and the fifth coolant port (1315) of the first-1 unit valve (1310) may be connected by the second internal coolant valve passage (1318); the second coolant port (1312) and the third coolant port (1313) of the first-1 unit valve (1310) may be connected by the third internal coolant valve passage (1319); and the seventh coolant port (1321) and the ninth coolant port (1323) of the first-2 unit valve (1320) may be connected by the fourth internal coolant valve passage (1327).

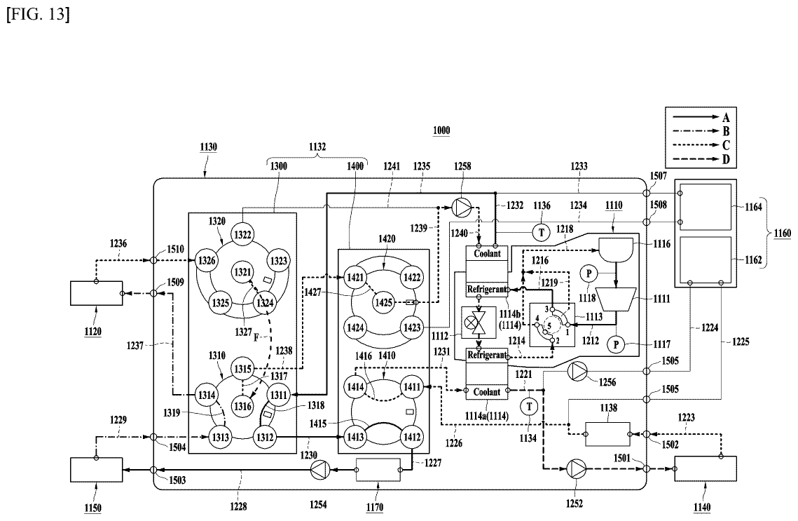

As shown in FIGS. 13, 14, and 16, in a fifth coolant valve mode, a fourth coolant port (1314) and a sixth coolant port (1316) of the first unit valve (1310) may be connected by a first internal passage (1317) of the coolant valve, a first coolant port (1311) and a fifth coolant port (1315) of the first unit valve (1310) may be connected by a second internal passage (1318) of the coolant valve, a second coolant port (1312) and a third coolant port (1313) of the first unit valve (1310) may be connected by a third internal passage (1319) of the coolant valve, and a seventh coolant port (1321) and a ninth coolant port (1323) of the second unit valve (1320) may be connected by a fourth internal passage (1327) of the coolant valve.

Referring to FIGS. 1 to 15 and FIG. 17, a second coolant control valve (1400) of the present embodiment may operate in one of a sixth coolant valve mode, a seventh coolant valve mode, an eighth coolant valve mode, or a ninth coolant valve mode. In this case, a second-1 unit valve (1410) and a second-2 unit valve (1420) of the second coolant control valve (1400) may be rotated together at a predetermined rotation angle (e.g., 90 degrees), so that one of the sixth to ninth coolant valve modes may be selectively switched.

As shown in FIGS. 2, 3, 4, 6, 7, 8, and 17, in the sixth coolant valve mode, a fifteenth coolant port (1413) and a sixteenth coolant port (1414) of the second-1 unit valve (1410) may be connected by a fifth internal passage (1415) of the coolant valve, a thirteenth coolant port (1411) and a fourteenth coolant port (1412) of the second-1 unit valve (1410) may be connected by a sixth internal passage (1416) of the coolant valve, and a twenty-first coolant port (1425) and an eighteenth coolant port (1422) of the second-2 unit valve (1420) may be connected by a seventh internal passage (1427) of the coolant valve.

As shown in FIGS. 9, 12, and 17, in the seventh coolant valve mode, a thirteenth coolant port (1411) and a sixteenth coolant port (1414) of the second-1 unit valve (1410) may be connected by the fifth internal passage (1415) of the coolant valve, a fourteenth coolant port (1412) and a fifteenth coolant port (1413) of the second-1 unit valve (1410) may be connected by the sixth internal passage (1416) of the coolant valve, and a twenty-first coolant port (1425) and a nineteenth coolant port (1423) of the second-2 unit valve (1420) may be connected by the seventh internal passage (1427) of the coolant valve.

As shown in FIGS. 5, 10, 11, and 17, in an eighth coolant valve mode, a thirteenth coolant port (1411) and a fourteenth coolant port (1412) of the second-1 unit valve (1410) may be connected by a fifth internal passage (1415) of the coolant valve, a fifteenth coolant port and a sixteenth coolant port (1414) of the second-1 unit valve (1410) may be connected by a sixth internal passage of the coolant valve, and a twenty-first coolant port (1425) and an eighteenth coolant port (1422) of the second-2 unit valve (1420) may be connected by a seventh internal passage (1427) of the coolant valve.

As shown in FIGS. 13, 14, 15, and 17, in a ninth coolant valve mode, a fourteenth coolant port (1412) and a fifteenth coolant port (1413) of the second-1 unit valve (1410) may be connected by the fifth internal passage (1415) of the coolant valve, a thirteenth coolant port (1411) and a sixteenth coolant port (1414) of the second-1 unit valve (1410) may be connected by the sixth internal passage (1416) of the coolant valve, and a twenty-first coolant port (1425) and a seventeenth coolant port (1421) of the second-2 unit valve (1420) may be connected by the seventh internal passage (1427) of the coolant valve.

The temperature control modes of the temperature management system (1000) for an electric vehicle according to an embodiment of the present invention, configured as described above, are as follows in detail.

For reference, in FIGS. 2 to 17, various types of arrows (A, B, C, D) are used to clearly indicate the flow directions and temperatures of the refrigerant and coolant flowing in the heat pump unit (1110) and the temperature management unit (1130). In this case, the arrows (A, B, C, D) shown in the heat pump unit (1110) represent the refrigerant flowing along the refrigerant circulation lines (1212, 1214, 1216, 1218), and the arrows (A, B, C, D) shown in the temperature management unit (1130) represent the coolant flowing along the coolant circulation lines (1221 to 1241).

For example, a solid arrow (A) indicates a high-temperature refrigerant or coolant, a dash-dot arrow (B) indicates a medium-high-temperature refrigerant or coolant, a short dashed arrow (C) indicates a medium-low-temperature refrigerant or coolant, and a long dashed arrow (D) indicates a low-temperature refrigerant or coolant.

FIGS. 2 to 15 respectively illustrate temperature control modes of the temperature management system (1000) according to the present embodiment.

Referring to FIGS. 2 to 15, the temperature control modes of the temperature management system (1000) according to the present embodiment may be variously determined by individually combining the first to third refrigerant valve modes of the refrigerant switching valve (1113), the first to fifth coolant valve modes of the first coolant control valve (1300), and the sixth to ninth coolant valve modes of the second coolant control valve (1400), to manage the temperature of an electric vehicle.

For example, the temperature control modes of the temperature management system (1000) according to the present embodiment may include: an ambient heat absorption heating mode, an inefficient heating mode, an inefficient heating and drying mode, a waste heat recovery heating mode, an ambient heat absorption battery warm-up mode, an inefficient battery warm-up mode, an inefficient battery warm-up and drying mode, a battery heat storage mode, a defogging mode, a defrosting mode, a dehumidification mode, a charging cooling mode, a battery cooling and air conditioning mode, and an electrical component warm-up and air conditioning mode.

FIG. 2 is a diagram illustrating the ambient heat absorption heating mode of the temperature management system (1000) shown in FIG. 1.

As illustrated in FIG. 2, the ambient heat absorption heating mode is executed under environmental conditions in which the ambient temperature is higher than the evaporation temperature of the refrigerant. In this mode, the temperature of the battery pack (1140), the first coolant-air heat exchanger (1162), and the electrical component module (1150) may be increased by using coolant heated to a high temperature through the first refrigerant-coolant heat exchanger (1114a), and the ambient temperature may be absorbed by the second refrigerant-coolant heat exchanger (1114b) through the radiator (1120).

In the ambient heat absorption heating mode as described above, the refrigerant switching valve (1113) may operate in the first refrigerant valve mode, the first coolant control valve (1300) may operate in the first coolant valve mode, and the second coolant control valve (1400) may operate in the sixth coolant valve mode.

Here, the coolant control valve (1132) delivers the coolant, which is heated to a high temperature by the first refrigerant-coolant heat exchanger (1114a), to the battery pack (1140) and the first coolant-air heat exchanger (1162), thereby increasing the temperature of the battery pack (1140) and the first coolant-air heat exchanger (1162). In addition, the coolant control valve (1132) delivers the coolant, which is cooled to a medium-high temperature at the battery pack (1140) and the first coolant-air heat exchanger (1162), to the electrical component module (1150), thereby increasing the temperature of the electrical component module (1150). Furthermore, the coolant control valve (1132) delivers the coolant, which is heat-exchanged to a medium temperature by the ambient air through the radiator (1120), to the second refrigerant-coolant heat exchanger (1114b), thereby increasing the temperature of the second refrigerant-coolant heat exchanger (1114b).

Meanwhile, the outdoor-heat absorption heating mode is a mode that utilizes indirect evaporation through the radiator (1120) during winter, when the evaporation temperature of the refrigerant is lower than the outdoor temperature. In the outdoor-heat absorption heating mode, the coolant circulation passages formed between the radiator (1120) and the second refrigerant-coolant heat exchanger (1162), and the coolant circulation passages formed between the battery pack (1140), the electric component module (1150), the first coolant-air heat exchanger (1162), and the first refrigerant-coolant heat exchanger (1114a), are separated from each other so that the coolant may flow independently.

FIG. 3 is a diagram illustrating an inefficient heating mode of the thermal management system (1000) shown in FIG. 1.

As illustrated in FIG. 3, the inefficient heating mode is carried out under severe cold conditions where outdoor heat absorption is not possible, and allows the temperature of the battery pack (1140), the first coolant-air heat exchanger (1162), and the electric component module (1150) to be increased by utilizing high-temperature coolant heated by the first refrigerant-coolant heat exchanger (1114a). Additionally, residual heat of the coolant having raised the temperature of the battery pack (1140), the first coolant-air heat exchanger (1162), and the electric component module (1150) may be provided to the second refrigerant-coolant heat exchanger (1114b).

In the inefficient heating mode described above, the refrigerant switching valve (1113) may operate in the first refrigerant valve mode, the first coolant control valve (1300) may operate in the third coolant valve mode, and the second coolant control valve (1400) may operate in the sixth coolant valve mode.

Here, the coolant control valve (1132) may deliver high-temperature coolant heated by the first refrigerant-coolant heat exchanger (1114a) to the battery pack (1140) and the first coolant-air heat exchanger (1162) so as to raise the temperature of the battery pack (1140) and the first coolant-air heat exchanger (1162). In addition, the coolant control valve (1132) may deliver the medium-high-temperature coolant cooled at the battery pack (1140) and the first coolant-air heat exchanger (1162) to the electric component module (1150) to increase the temperature of the electric component module (1150). Furthermore, the coolant control valve (1132) may deliver the medium-low-temperature coolant cooled at the electric component module (1150) to the second refrigerant-coolant heat exchanger (1114b) to raise the temperature of the second refrigerant-coolant heat exchanger (1114b).

Meanwhile, the inefficient heating mode is a heating mode that utilizes the residual heat of the coolant that has heated the battery pack (1140), the electric component module (1150), and the first coolant-air heat exchanger (1162). The inefficient heating mode may be used under harsh cold conditions where outdoor heat absorption is not feasible, and the compressor (1111) of the heat pump unit (1110) may function as a heater.

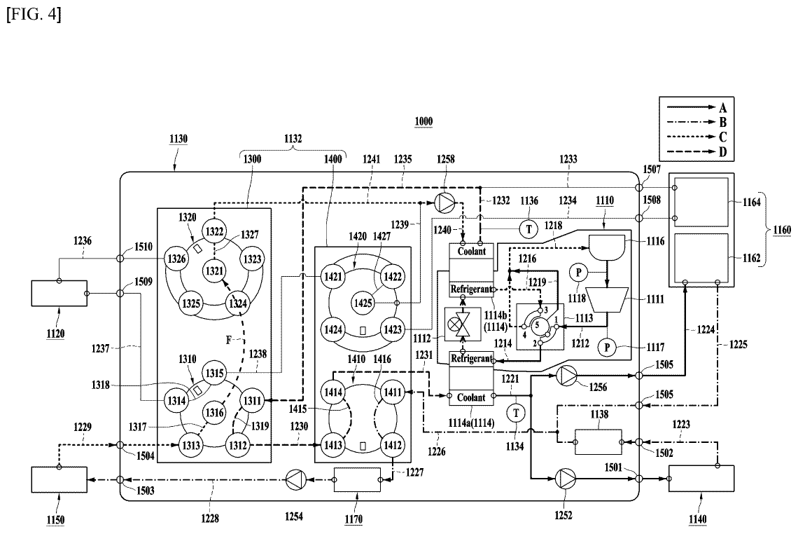

FIG. 4 is a diagram illustrating an inefficient heating and drying mode of the thermal management system (1000) shown in FIG. 1.

As illustrated in FIG. 4, the inefficient heating and drying mode is carried out under severe cold conditions where outdoor heat absorption is not feasible, and allows the temperature of the battery pack (1140), the first coolant-air heat exchanger (1162), and the electric component module (1150) to be increased by utilizing high-temperature coolant heated by the first refrigerant-coolant heat exchanger (1114a). In addition, residual heat of the coolant, which has raised the temperature of the battery pack (1140), the first coolant-air heat exchanger (1162), and the electric component module (1150), may be supplied to the second refrigerant-coolant heat exchanger (1114b), and particularly, high-temperature refrigerant compressed by the compressor may be bypassed to the fourth refrigerant line (1218) through the refrigerant bypass unit (5, 1219).

In the inefficient heating and drying mode as described above, the refrigerant switching valve (1113) may operate in the third refrigerant valve mode, the first coolant control valve (1300) may operate in the third coolant valve mode, and the second coolant control valve (1400) may operate in the sixth coolant valve mode.

Here, the coolant control valve (1132) may deliver high-temperature coolant heated by the first refrigerant-coolant heat exchanger (1114a) to the battery pack (1140) and the first coolant-air heat exchanger (1162) to raise the temperatures of the battery pack (1140) and the first coolant-air heat exchanger (1162). In addition, the coolant control valve (1132) may deliver the medium-high-temperature coolant, which has been cooled at the battery pack (1140) and the first coolant-air heat exchanger (1162), to the electric component module (1150) to increase the temperature of the electric component module (1150). Furthermore, the coolant control valve (1132) may deliver the medium-low-temperature coolant, which has been cooled at the electric component module (1150), to the second refrigerant-coolant heat exchanger (1114b) to raise the temperature of the second refrigerant-coolant heat exchanger (1114b).

Meanwhile, the inefficient heating and drying mode is a heating mode that utilizes the residual heat of the coolant which has heated the battery pack (1140), the electric component module (1150), and the first coolant-air heat exchanger (1162). However, unlike the inefficient heating mode, the inefficient heating and drying mode improves the low dryness of the heat pump unit (1110) caused by inefficient heating by bypassing a portion of the refrigerant discharged from the compressor (1111) to the inlet side of the compressor (1111) via the refrigerant bypass unit (5, 1219).

FIG. 5 is a diagram illustrating a waste heat recovery heating mode of the thermal management system (1000) shown in FIG. 1.

As illustrated in FIG. 5, the waste heat recovery heating mode is carried out under extremely cold conditions to enhance the cabin heating performance of the electric vehicle, and allows the temperature of the battery pack (1140) and the electric component module (1150) to be decreased by using low-temperature coolant cooled by the first refrigerant-coolant heat exchanger (1114a), and allows high-temperature coolant heated by the second refrigerant-coolant heat exchanger (1114b) to be supplied to the second coolant-air heat exchanger (1164).

In the waste heat recovery heating mode as described above, the refrigerant switching valve (1113) may operate in the second refrigerant valve mode, the first coolant control valve (1300) may operate in the fourth coolant valve mode, and the second coolant control valve (1400) may operate in the eighth coolant valve mode.

Here, the coolant control valve (1132) may deliver low-temperature coolant cooled by the first refrigerant-coolant heat exchanger (1114a) to the battery pack (1140) to reduce the temperature of the battery pack (1140). In addition, the coolant control valve (1132) may deliver medium-low-temperature coolant, which has been heated at the battery pack (1140), to the electric component module (1150) to reduce the temperature of the electric component module (1150). Furthermore, the coolant control valve (1132) may deliver medium-high-temperature coolant, which has been heated at the electric component module (1150), to the first refrigerant-coolant heat exchanger (1114a) to recover waste heat from the battery pack (1140) and the electric component module (1150). Additionally, the coolant control valve (1132) may deliver high-temperature coolant heated by the second refrigerant-coolant heat exchanger (1114b) to the second coolant-air heat exchanger (1164) to raise the temperature of the second coolant-air heat exchanger (1164).

Meanwhile, the waste heat recovery heating mode is a mode that enhances cabin heating performance under extreme cold conditions even when the temperature of the battery pack (1140) is low, provided that the battery pack (1140) and the electric component module (1150) retain a certain level of residual heat. In the waste heat recovery heating mode, the residual heat of the battery pack (1140) and the electric component module (1150) may be utilized to heat the second coolant-air heat exchanger (1164).

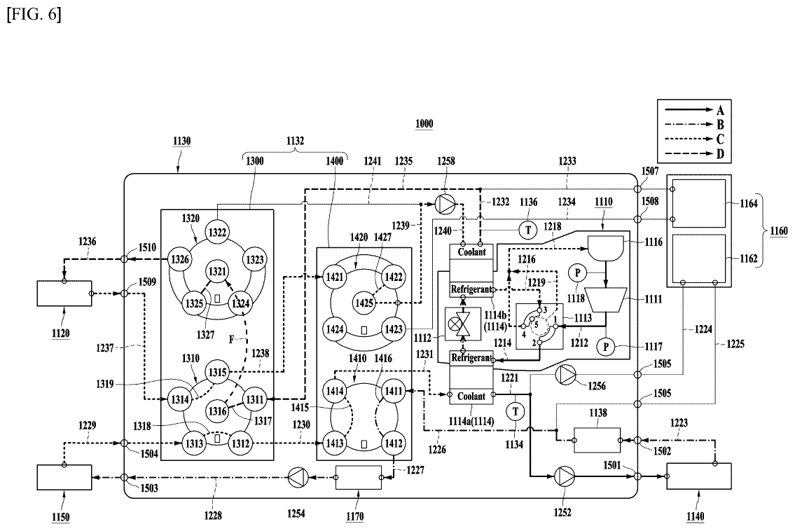

FIG. 6 is a diagram illustrating an ambient heat absorption battery warm-up mode of the thermal management system (1000) shown in FIG. 1.

As illustrated in FIG. 6, the ambient heat absorption battery warm-up mode is carried out under environmental conditions where cabin air conditioning of the electric vehicle is unnecessary. In this mode, the temperature of the battery pack (1140) and the electric component module (1150) may be increased using high-temperature coolant heated by the first refrigerant-coolant heat exchanger (1114a), and ambient heat may be absorbed into the second refrigerant-coolant heat exchanger (1114b) via the radiator (1120).

In the ambient heat absorption battery warm-up mode as described above, the refrigerant switching valve (1113) may operate in the first refrigerant valve mode, the first coolant control valve (1300) may operate in the first coolant valve mode, and the second coolant control valve (1400) may operate in the sixth coolant valve mode.

Here, the coolant control valve (1132) may deliver high-temperature coolant heated by the first refrigerant-coolant heat exchanger (1114a) to the battery pack (1140) to increase the temperature of the battery pack (1140). In addition, the coolant control valve (1132) may deliver medium-high-temperature coolant, which has been cooled at the battery pack (1140), to the electric component module (1150) to increase the temperature of the electric component module (1150). Furthermore, the coolant control valve (1132) may deliver medium-low-temperature coolant, which has been heat-exchanged by ambient air in the radiator (1120), to the second refrigerant-coolant heat exchanger (1114b) to increase the temperature of the second refrigerant-coolant heat exchanger (1114b).

Meanwhile, the ambient heat absorption battery warm-up mode is a mode for warming up the battery pack (1140) while the operation of the air conditioning system is suspended. In the ambient heat absorption battery warm-up mode, when the occupant does not request heating or when the cabin is already sufficiently warm, the indoor heating and cooling by the first and second coolant-air heat exchangers (1162, 1164) of the air conditioning system may be suspended, and in that state, heat absorption via the radiator (1120) may be utilized to warm up the battery pack (1140).

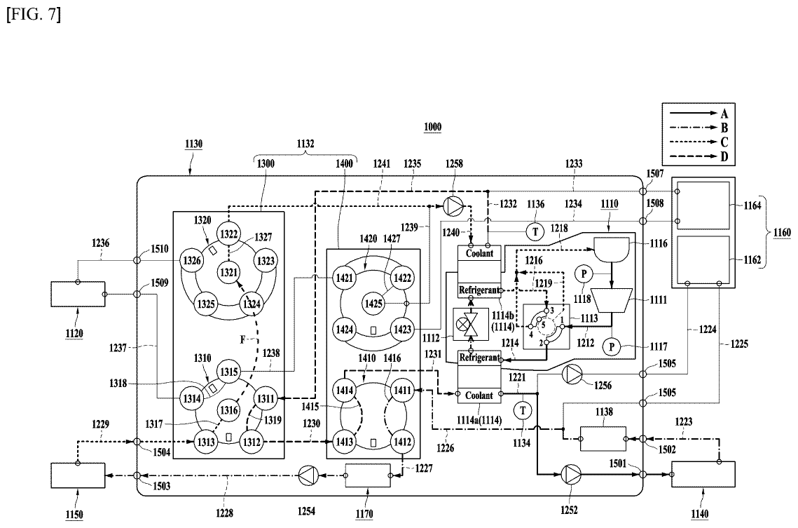

FIG. 7 is a diagram illustrating an inefficient battery warm-up mode of the thermal management system (1000) shown in FIG. 1.

As illustrated in FIG. 7, the inefficient battery warm-up mode is carried out under environmental conditions where cabin air conditioning of the electric vehicle is unnecessary. In this mode, the temperature of the battery pack (1140) and the electric component module (1150) may be increased using high-temperature coolant heated by the first refrigerant-coolant heat exchanger (1114a), and the residual heat of the coolant, which has increased the temperature of the battery pack (1140) and the electric component module (1150), may be supplied to the second refrigerant-coolant heat exchanger (1114b).

In the inefficient battery warm-up mode as described above, the refrigerant switching valve (1113) may operate in the first refrigerant valve mode, the first coolant control valve (1300) may operate in the third coolant valve mode, and the second coolant control valve (1400) may operate in the sixth coolant valve mode.

Here, the coolant control valve (1132) may deliver high-temperature coolant heated by the first refrigerant-coolant heat exchanger (1114a) to the battery pack (1140) to increase the temperature of the battery pack (1140). Alternatively, the coolant control valve (1132) may deliver medium-high-temperature coolant, which has been cooled at the battery pack (1140), to the electric component module (1150) to increase the temperature of the electric component module (1150). Furthermore, the coolant control valve (1132) may deliver medium-low-temperature coolant, which has been cooled at the electric component module (1150), to the second refrigerant-coolant heat exchanger (1114b) to increase the temperature of the second refrigerant-coolant heat exchanger (1114b).

Meanwhile, the inefficient battery warm-up mode is a mode for rapidly warming up the battery pack (1140) while the operation of the air conditioning system is suspended, and also serves as a heating mode using the residual heat of the coolant that has heated the battery pack (1140) and the electric component module (1150). The inefficient battery warm-up mode may be carried out when cabin heating reaches a certain level.

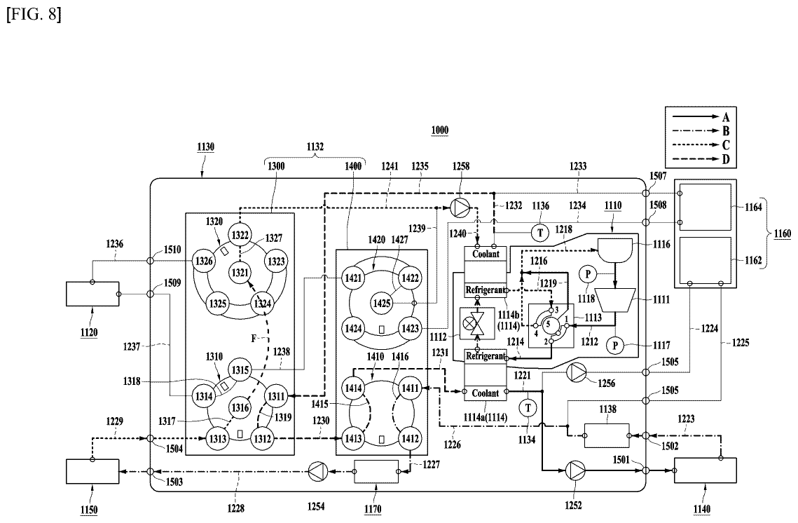

FIG. 8 is a diagram illustrating an inefficient battery warm-up drying mode of the thermal management system (1000) shown in FIG. 1.

As illustrated in FIG. 8, the inefficient battery warm-up drying mode is carried out under environmental conditions in which cabin air conditioning of the electric vehicle is unnecessary. In this mode, the temperature of the battery pack (1140) and the electric component module (1150) may be increased using high-temperature coolant heated by the first refrigerant-coolant heat exchanger (1114a), and the residual heat of the coolant, which has increased the temperature of the battery pack (1140) and the electric component module (1150), may be supplied to the second refrigerant-coolant heat exchanger (1114b). In particular, high-temperature refrigerant compressed by the compressor may be bypassed through the refrigerant bypass unit (5, 1219) to the fourth refrigerant line (1218).

In the inefficient battery warm-up drying mode as described above, the refrigerant switching valve (1113) may operate in the third refrigerant valve mode, the first coolant control valve (1300) may operate in the third coolant valve mode, and the second coolant control valve (1400) may operate in the sixth coolant valve mode.

Here, the coolant control valve (1132) may deliver high-temperature coolant heated by the first refrigerant-coolant heat exchanger (1114a) to the battery pack (1140) to increase the temperature of the battery pack (1140). Alternatively, the coolant control valve (1132) may deliver medium-high-temperature coolant, which has been cooled at the battery pack (1140), to the electric component module (1150) to increase the temperature of the electric component module (1150). Furthermore, the coolant control valve (1132) may deliver medium-low-temperature coolant, which has been cooled at the electric component module (1150), to the second refrigerant-coolant heat exchanger (1114b) to increase the temperature of the second refrigerant-coolant heat exchanger (1114b).

Meanwhile, the inefficient battery warm-up drying mode is a mode for rapidly warming up the battery pack (1140) while the operation of the air conditioning system is suspended, and also serves as a heating mode using the residual heat of the coolant that has heated the battery pack (1140) and the electric component module (1150). However, unlike the inefficient battery warm-up mode, the inefficient battery warm-up drying mode bypasses part of the refrigerant discharged from the compressor (1111) back to the inlet side of the compressor (1111) through the refrigerant bypass unit (5, 1219), thereby increasing the dryness level of the heat pump unit (1110), which may otherwise be reduced due to inefficient heating.

FIG. 9 is a diagram illustrating a battery heat storage mode of the thermal management system (1000) shown in FIG. 1.

As illustrated in FIG. 9, the battery heat storage mode is carried out under environmental conditions in which an indoor heating heat source of the electric vehicle is available during winter when the driver is absent. In this mode, the temperature of the battery pack (1140) may be increased using high-temperature coolant heated by the first refrigerant-coolant heat exchanger (1114a), and the indoor heating heat source of the electric vehicle may be supplied to the second refrigerant-coolant heat exchanger (1114b).

In the battery heat storage mode as described above, the refrigerant switching valve (1113) may operate in the third refrigerant valve mode, the first coolant control valve (1300) may operate in the second coolant valve mode, and the second coolant control valve (1400) may operate in the seventh coolant valve mode.

Here, the coolant control valve (1132) may deliver high-temperature coolant heated by the first refrigerant-coolant heat exchanger (1114a) to the battery pack (1140) to increase the temperature of the battery pack (1140). The coolant control valve (1132) may deliver medium-low-temperature coolant cooled by the radiator (1120) to the electric component module (1150) to cool the temperature of the electric component module (1150). The coolant control valve (1132) may deliver low-temperature coolant cooled by the second refrigerant-coolant heat exchanger (1114b) to the second coolant-air heat exchanger (1164) to cool the cabin air.

Meanwhile, the battery heat storage mode is a mode for heating the battery pack (1140) using the indoor heating heat source of the electric vehicle when the driver is absent before or after driving in winter. In the battery heat storage mode, only the battery pack (1140) may be heated using the indoor heating heat source, and the electric component module (1150) may be cooled by the radiator (1120) while being in a non-operating state.

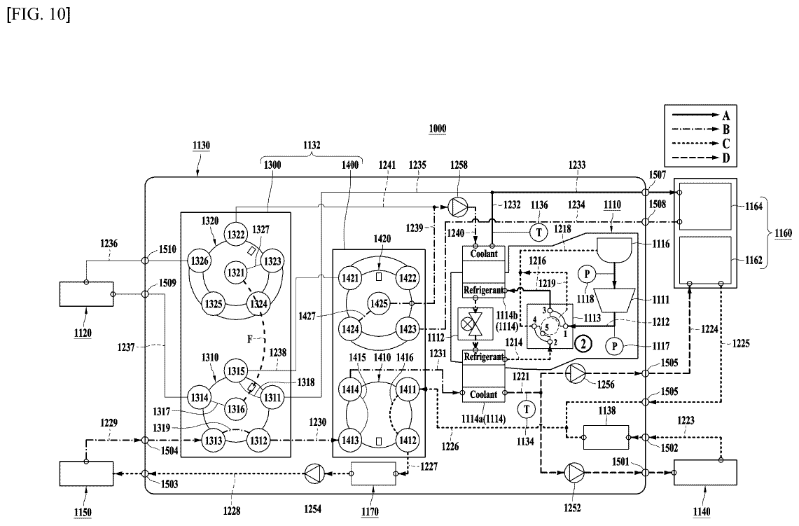

FIG. 10 is a diagram illustrating a defogging mode of the thermal management system (1000) shown in FIG. 1.

As illustrated in FIG. 10, the defogging mode is carried out under environmental conditions requiring the removal of fog. In this mode, the temperature of the battery pack (1140), the first coolant-air heat exchanger (1162), and the electric component module (1150) may be reduced using low-temperature coolant cooled by the first refrigerant-coolant heat exchanger (1114a), and high-temperature coolant heated by the second refrigerant-coolant heat exchanger (1114b) may be supplied to the second coolant-air heat exchanger (1164).

In the defogging mode as described above, the refrigerant switching valve (1113) may operate in the second refrigerant valve mode, the first coolant control valve (1300) may operate in the third coolant valve mode, and the second coolant control valve (1400) may operate in the eighth coolant valve mode.

Here, the coolant control valve (1132) may deliver low-temperature coolant cooled by the first refrigerant-coolant heat exchanger (1114a) to the battery pack (1140) and the first coolant-air heat exchanger (1162) to reduce the temperature of the battery pack (1140) and the first coolant-air heat exchanger (1162). The coolant control valve (1132) may also deliver medium-low-temperature coolant, heated by the battery pack (1140) and the first coolant-air heat exchanger (1162), to the electric component module (1150) to reduce the temperature of the electric component module (1150). The coolant control valve (1132) may further deliver medium-high-temperature coolant heated by the electric component module (1150) to the first refrigerant-coolant heat exchanger (1114a) to recover waste heat from the battery pack (1140), the first coolant-air heat exchanger (1162), and the electric component module (1150). Additionally, the coolant control valve (1132) may deliver high-temperature coolant heated by the second refrigerant-coolant heat exchanger (1114b) to the second coolant-air heat exchanger (1164) to increase the temperature of the second coolant-air heat exchanger (1164).

Meanwhile, the defogging mode is a mode that removes fog by collecting moisture contained in the air inside the air conditioning device and then heating it. In the defogging mode, moisture in the air may be collected using the first coolant-air heat exchanger (1162) cooled by low-temperature coolant, and the moisture-removed air may be heated using the second coolant-air heat exchanger (1164) heated by high-temperature coolant, and then discharged toward the fogged area of the electric vehicle.

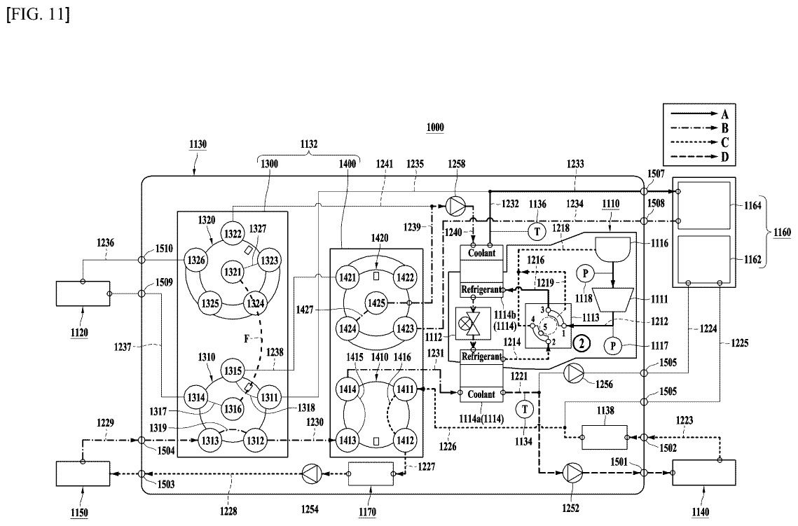

FIG. 11 is a diagram illustrating a defrost mode of the thermal management system (1000) shown in FIG. 1.

As illustrated in FIG. 11, the defrost mode is carried out under environmental conditions where defrosting of the coolant-air heat exchanger (1160) is required and air conditioning for the electric vehicle interior is unnecessary. In this mode, the temperature of the battery pack (1140) and the electric component module (1150) may be lowered using low-temperature coolant cooled by the first refrigerant-coolant heat exchanger (1114a), and high-temperature coolant heated by the second refrigerant-coolant heat exchanger (1114b) may be supplied to the second coolant-air heat exchanger (1164). At this time, the supply of coolant to the first coolant-air heat exchanger (1162) may be shut off.

In the defrost mode as described above, the refrigerant switching valve (1113) may operate in the second refrigerant valve mode, the first coolant control valve (1300) may operate in the third coolant valve mode, and the second coolant control valve (1400) may operate in the eighth coolant valve mode.

Here, the coolant control valve (1132) may deliver low-temperature coolant cooled by the first refrigerant-coolant heat exchanger (1114a) to the battery pack (1140) to reduce the temperature of the battery pack (1140). The coolant control valve (1132) may also deliver medium-low-temperature coolant, heated by the battery pack (1140), to the electric component module (1150) to reduce the temperature of the electric component module (1150). Further, the coolant control valve (1132) may deliver medium-high-temperature coolant heated by the electric component module (1150) to the first refrigerant-coolant heat exchanger (1114a) to recover waste heat from the battery pack (1140) and the electric component module (1150). Additionally, the coolant control valve (1132) may deliver high-temperature coolant heated by the second refrigerant-coolant heat exchanger (1114b) to the second coolant-air heat exchanger (1164) to increase the temperature of the second coolant-air heat exchanger (1164).

Meanwhile, the defrost mode is a mode that cancels the supercooled state of the first coolant-air heat exchanger (1162) of the air conditioning system. This mode corresponds to a state in which only the operation of the first coolant-air heat exchanger (1162) is stopped during the defogging mode. In the defrost mode, the operation of the first coolant-air heat exchanger (1162) may be stopped to suspend moisture collection from the air, and in this state, indoor air may be heated using the second coolant-air heat exchanger (1164) heated by high-temperature coolant, thereby removing frost formed on the first coolant-air heat exchanger (1162).

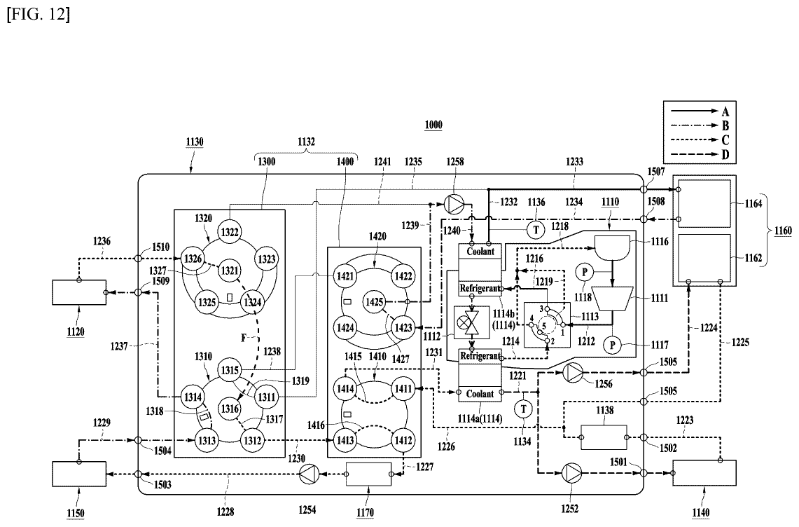

FIG. 12 is a diagram illustrating a dehumidification mode of the thermal management system (1000) shown in FIG. 1.

As illustrated in FIG. 12, the dehumidification mode is carried out under environmental conditions requiring dehumidification of indoor air in the electric vehicle. In this mode, the temperature of the battery pack (1140) and the first coolant-air heat exchanger (1162) may be lowered using low-temperature coolant cooled by the first refrigerant-coolant heat exchanger (1114a), and high-temperature coolant heated by the second refrigerant-coolant heat exchanger (1114b) may be supplied to the second coolant-air heat exchanger (1164) to remove moisture collected in the first coolant-air heat exchanger (1162).

In the dehumidification mode as described above, the refrigerant switching valve (1113) may operate in the second refrigerant valve mode, the first coolant control valve (1300) may operate in the second coolant valve mode, and the second coolant control valve (1400) may operate in the seventh coolant valve mode.

Here, the coolant control valve (1132) may deliver low-temperature coolant cooled by the first refrigerant-coolant heat exchanger (1114a) to the battery pack (1140) and the first coolant-air heat exchanger (1162) to lower the temperatures of the battery pack (1140) and the first coolant-air heat exchanger (1162). Additionally, the coolant control valve (1132) may deliver medium-low-temperature coolant, heated by the battery pack (1140) and the first coolant-air heat exchanger (1162), back to the first refrigerant-coolant heat exchanger (1114a) to recover waste heat from the battery pack (1140) and the first coolant-air heat exchanger (1162). Furthermore, the coolant control valve (1132) may deliver high-temperature coolant heated by the second refrigerant-coolant heat exchanger (1114b) from the second coolant flow path (232) to the second coolant-air heat exchanger (1164) to raise the temperature of the second coolant-air heat exchanger (1164). The coolant control valve (1132) may also deliver medium-low-temperature coolant, heat-exchanged with outdoor air by the radiator (1120), to the electric component module (1150) to lower the temperature of the electric component module (1150).

Meanwhile, the dehumidification mode is a mode used for summer dehumidification while utilizing residual heat of the battery pack (1140) under environmental conditions requiring cooling of the battery pack (1140) and indoor air. In the dehumidification mode, moisture from the air may be collected at the first refrigerant-coolant heat exchanger (1114a) cooled by low-temperature coolant, and the battery pack (1140) may also be cooled by the low-temperature coolant. At this time, the electric component module (1150) may be independently cooled by the radiator (1120).

FIG. 13 is a diagram illustrating a charging cooling mode of the thermal management system (1000) shown in FIG. 1.

As illustrated in FIG. 13, the charging cooling mode is carried out under environmental conditions in which the battery pack is undergoing high-power charging in the absence of passengers. In this mode, the temperature of the battery pack (1140) may be lowered using low-temperature coolant cooled by the first refrigerant-coolant heat exchanger (1114a), and high-temperature coolant heated by the second refrigerant-coolant heat exchanger (1114b) may be supplied to the electric component module (1150), and then cooled via the radiator.

In the charging cooling mode as described above, the refrigerant switching valve (1113) may operate in the second refrigerant valve mode, the first coolant control valve (1300) may operate in the fifth coolant valve mode, and the second coolant control valve (1400) may operate in the ninth coolant valve mode.

Here, the coolant control valve (1132) may deliver low-temperature coolant cooled by the first refrigerant-coolant heat exchanger (1114a) to the battery pack (1140) to lower the temperature of the battery pack (1140). Additionally, the coolant control valve (1132) may deliver high-temperature coolant heated by the second refrigerant-coolant heat exchanger (1114b) to the electric component module (1150), and after raising the temperature of the electric component module (1150), may deliver medium-high-temperature coolant cooled by the electric component module (1150) to the radiator (1120). Furthermore, the coolant control valve (1132) may supply medium-low-temperature coolant, heat-exchanged in the radiator (1120), to the second refrigerant-coolant heat exchanger (1114b).

Meanwhile, the charging cooling mode is a mode for stably performing high-power charging of the battery pack (1140) in the absence of passengers while the operation of the air conditioning system is stopped. In the charging cooling mode, only the battery pack (1140) may be cooled using low-temperature coolant cooled by the first refrigerant-coolant heat exchanger (1114a), and the electric component module (1150) may be heated using high-temperature coolant heated by the second refrigerant-coolant heat exchanger (1114b), and then cooled by the radiator (1120).

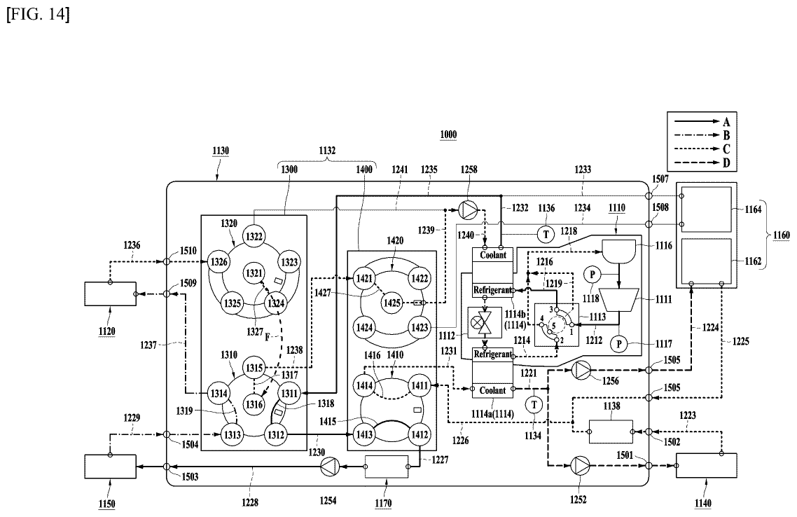

FIG. 14 is a diagram illustrating a battery cooling and air-conditioning mode of the thermal management system (1000) shown in FIG. 1.

As illustrated in FIG. 14, the battery cooling and air-conditioning mode is performed under environmental conditions requiring the cooling of the battery pack and cabin during the warm-up of the electric vehicle. In this mode, the temperature of the battery pack (1140) and the first coolant-air heat exchanger (1162) may be lowered using low-temperature coolant cooled by the first refrigerant-coolant heat exchanger (1114a), and high-temperature coolant heated by the second refrigerant-coolant heat exchanger (1114b) may be supplied to the electric component module (1150) and then cooled through the radiator (1120).

In the battery cooling and air-conditioning mode as described above, the refrigerant switching valve (1113) may operate in the second refrigerant valve mode, the first coolant control valve (1300) may operate in the fifth coolant valve mode, and the second coolant control valve (1400) may operate in the ninth coolant valve mode.

Here, the coolant control valve (1132) may deliver low-temperature coolant cooled by the first refrigerant-coolant heat exchanger (1114a) to the battery pack (1140) and the first coolant-air heat exchanger (1162) to lower the temperatures of the battery pack (1140) and the first coolant-air heat exchanger (1162). Additionally, the coolant control valve (1132) may deliver medium-low-temperature coolant, heated in the battery pack (1140) and the first coolant-air heat exchanger (1162), back to the first refrigerant-coolant heat exchanger (1114a) to recover waste heat. Furthermore, the coolant control valve (1132) may deliver high-temperature coolant heated by the second refrigerant-coolant heat exchanger (1114b) to the electric component module (1150) to raise its temperature. The coolant control valve (1132) may also deliver medium-high-temperature coolant, cooled in the electric component module (1150), to the radiator (1120) to further cool it to medium-low temperature, and then supply it to the second refrigerant-coolant heat exchanger (1114b).

Meanwhile, the battery cooling and air-conditioning mode is a mode that cools the cabin and the battery pack (1140) while utilizing residual heat from the warm-up of the battery pack (1140). In the battery cooling and air-conditioning mode, low-temperature coolant may cool both the battery pack (1140) and the first coolant-air heat exchanger (1162), and the electric component module (1150) may be cooled using the radiator (1120).

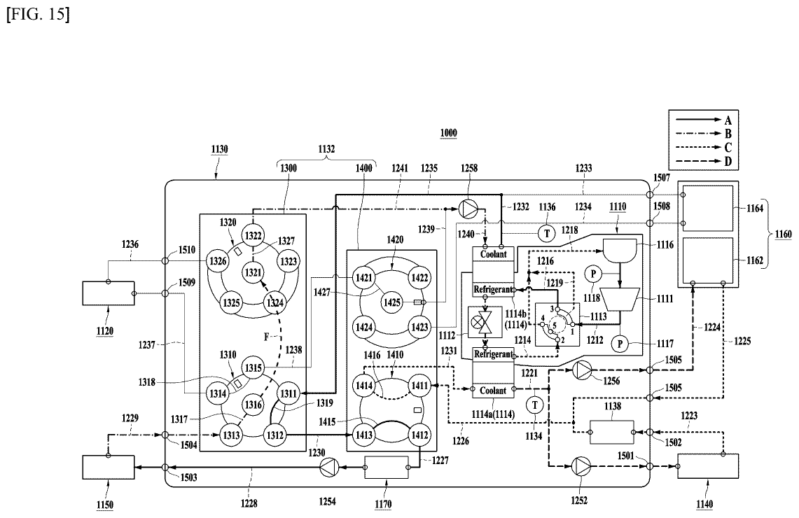

FIG. 15 is a diagram illustrating an electric component warm-up and cooling mode of the thermal management system (1000) shown in FIG. 1.

As illustrated in FIG. 15, the electric component warm-up and cooling mode is performed under environmental conditions requiring rapid warm-up of the electric component module (1150). In this mode, the temperature of the battery pack (1140) and the first coolant-air heat exchanger (1162) may be lowered using low-temperature coolant cooled by the first refrigerant-coolant heat exchanger (1114a), and high-temperature coolant heated by the second refrigerant-coolant heat exchanger (1114b) may be supplied to the electric component module (1150).

In the electric component warm-up and cooling mode as described above, the refrigerant switching valve (1113) may operate in the second refrigerant valve mode, the first coolant control valve (1300) may operate in the third coolant valve mode, and the second coolant control valve (1400) may operate in the ninth coolant valve mode.

Here, the coolant control valve (1132) may deliver low-temperature coolant cooled by the first refrigerant-coolant heat exchanger (1114a) to the battery pack (1140) and the first coolant-air heat exchanger (1162) to lower the temperatures of the battery pack (1140) and the first coolant-air heat exchanger (1162). In addition, the coolant control valve (1132) may deliver high-temperature coolant heated by the second refrigerant-coolant heat exchanger (1114b) to the electric component module (1150) to raise its temperature and then return the coolant to the second refrigerant-coolant heat exchanger (1114b).

Meanwhile, the electric component warm-up mode is a mode for rapidly warming up the electric component module (1150) to an optimal set temperature. In the electric component warm-up mode, high-temperature coolant heated by the second refrigerant-coolant heat exchanger (1114b) may directly and rapidly heat the electric component module (1150).

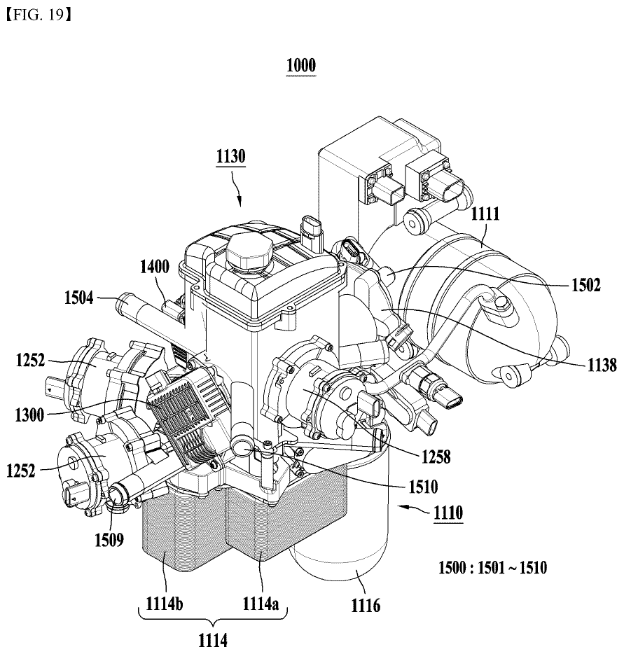

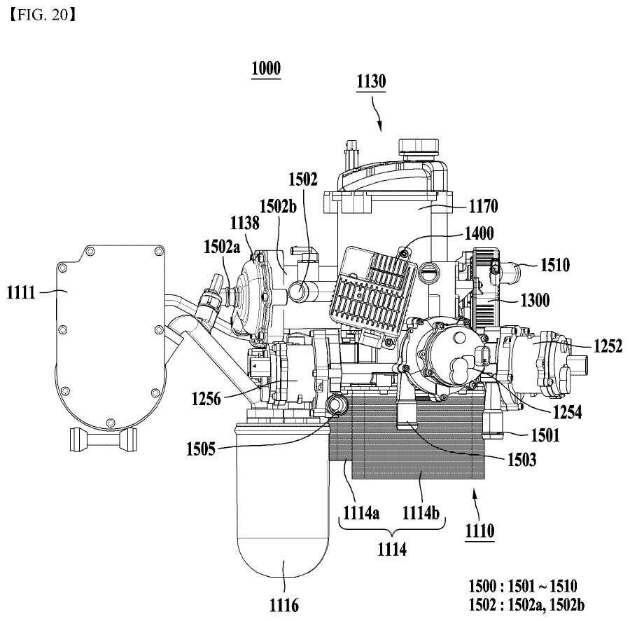

FIGS. 19 and 20 are a perspective view and a side view showing modeling examples of a thermal management system (1000) for an electric vehicle according to an embodiment of the present invention.

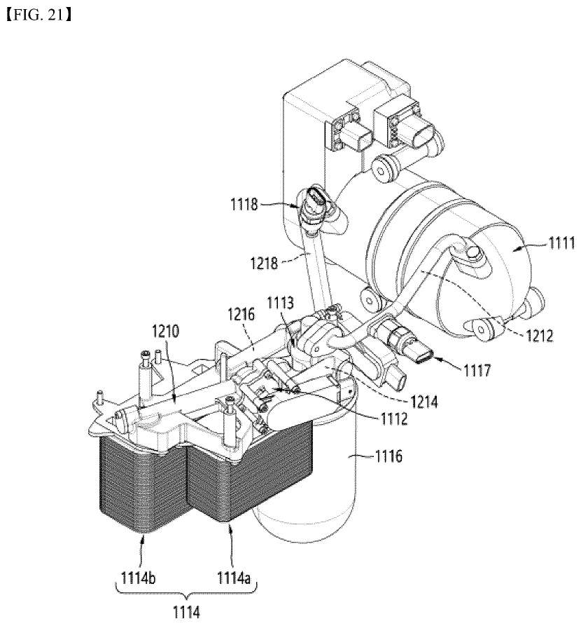

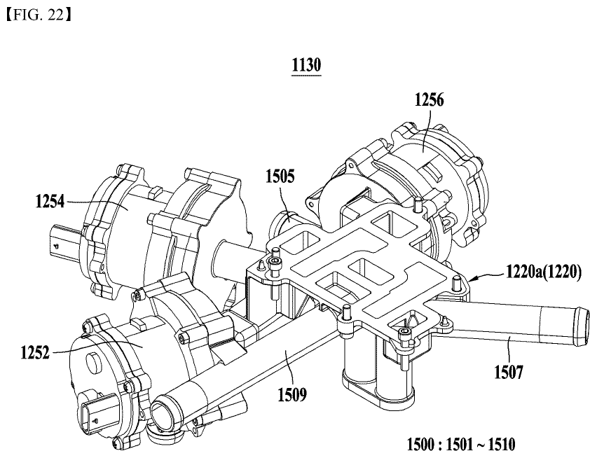

FIG. 21 is a diagram illustrating the heat pump unit (1110) of the thermal management system (1000) shown in FIGS. 19 and 20, FIG. 22 is a diagram illustrating an upper structure of the thermal management unit (1130) of the thermal management system (1000) shown in FIGS. 19 and 20, FIG. 23 is a diagram illustrating a lower structure of the thermal management unit (1130) of the thermal management system (1000) shown in FIGS. 19 and 20, and FIG. 24 is a diagram illustrating an upper body (1220b) of the valve housing (1220) shown in FIG. 22.

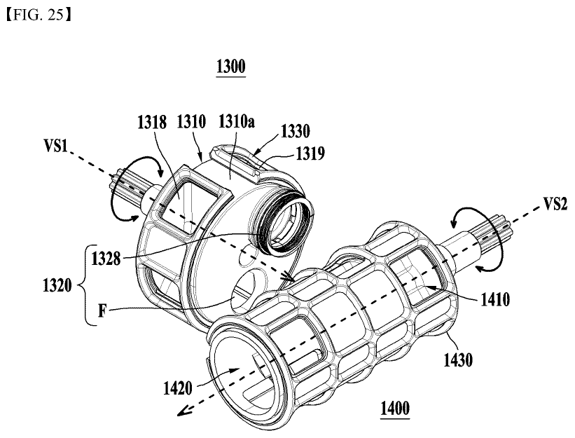

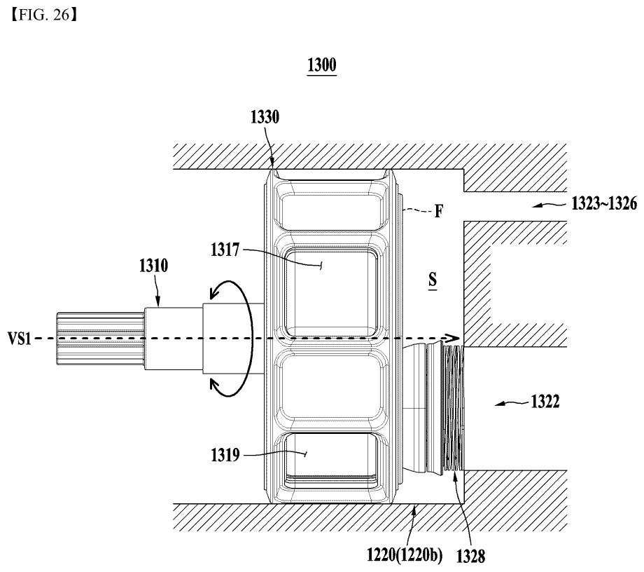

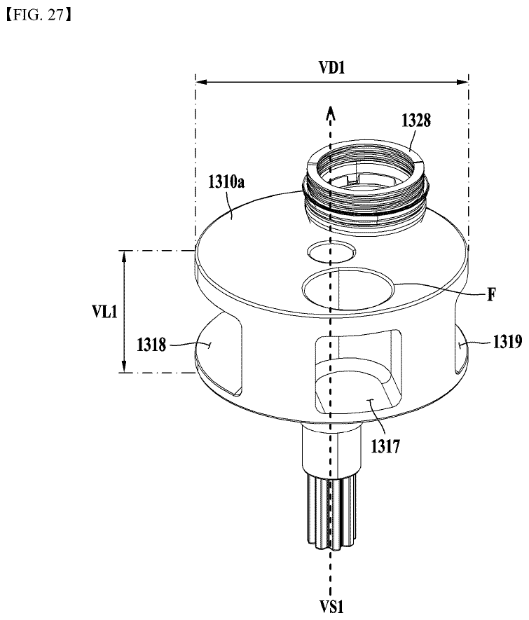

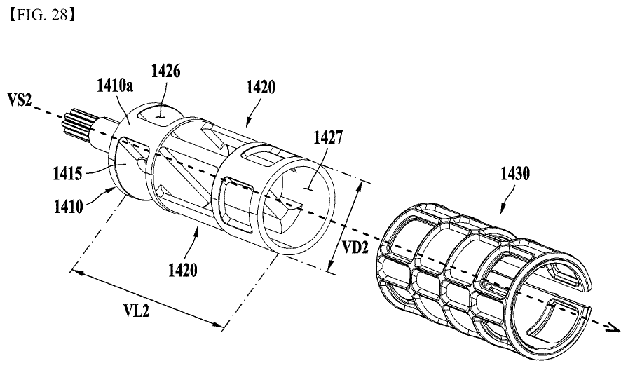

FIG. 25 is a diagram illustrating the coolant control valve (1132) of the valve housing (1220) shown in FIG. 22, FIG. 26 is a schematic view illustrating an installed state of the first coolant control valve (1300) shown in FIG. 25, FIG. 27 is a diagram illustrating a first-1 unit valve body (1310a) of the first coolant control valve (1300) shown in FIG. 26, and FIG. 28 is an exploded view of the second coolant control valve (1400) shown in FIG. 25.

FIGS. 19 and 20 show a real-world example of a design model of the thermal management system (1000) according to an embodiment of the present invention. In FIGS. 19 and 20, the same or similar reference numerals as those shown in FIGS. 1 to 18 represent the same components, and detailed descriptions thereof will be omitted. The following description will focus on differences from the thermal management system (1000) shown in FIGS. 1 to 18.

Referring to FIGS. 19 and 20, in this embodiment, the thermal management unit (1130) may be integrated and coupled in a unified structure seated on the upper part of the heat pump unit (1110). In this case, the refrigerant-coolant heat exchanger (1114) may be installed on one lower side of the heat pump unit (1110) so as to avoid interference with the thermal management unit (1130).

As a result, in this embodiment, the thermal management system (1000) may be installed in the interior space of the electric vehicle in a form where the heat pump unit (1110) and the thermal management unit (1130) are manufactured as a unified integrated structure, thereby significantly reducing the installation space of the thermal management system (100). In addition, hoses or pipes connecting components of the heat pump unit (1110) and the thermal management unit (1130) may be omitted, thus simplifying the entire structure and reducing the risk of failure.

The structure of the heat pump unit (1110) according to the present embodiment will now be described in detail with reference to FIGS. 19, 20, and 21.

Referring to FIGS. 19 to 21, the heat pump unit (1110) of the present embodiment may include a compressor (1111), expansion valve (1112), refrigerant switching valve (1113), refrigerant bypass section (5, 1219), and a heat pump body (1210).

The heat pump body (1210) may be detachably coupled to the lower part of the thermal management unit (1130). Inside the heat pump body (1210), refrigerant circulation paths (1212, 1214, 1216, 1218) may be formed. The heat pump body (1210) may be formed in a planar shape to ensure stable mounting and coupling with the thermal management unit (1130).

The expansion valve (1112) and the refrigerant switching valve (1113) may be installed at different positions on the heat pump body (1210). Each of the expansion valve (1112) and the refrigerant switching valve (1113) may be connected to different portions of the refrigerant circulation paths (1212, 1214, 1216, 1218) formed inside the heat pump body (1210).

Additionally, the compressor (1111) may be installed in a structure extended outward from the heat pump body (1210) so as to avoid interference with the thermal management unit (1130). That is, in the present embodiment, two refrigerant pipes forming the refrigerant circulation paths may be extended outward from the position where the thermal management unit (1130) is coupled, and the compressor (1111) may be connected to these two refrigerant pipes. Specifically, the two refrigerant pipes may include:-a first refrigerant pipe connecting the outlet of the compressor (1111) to the first refrigerant port (1) of the refrigerant switching valve (1113), forming a first refrigerant path (1212); and-a second refrigerant pipe connecting the fourth refrigerant port (4) of the refrigerant switching valve (1113) to the inlet of the compressor (1111), forming a fourth refrigerant path (1218).

Meanwhile, the heat pump unit (1110) may further include an accumulator (1116), a first pressure gauge (1117), and a second pressure gauge (1118).

The accumulator (1116) may be connected to the fourth refrigerant path (1218) of the refrigerant circulation paths (1212, 1214, 1216, 1218), and may be installed on the opposite lower side of the heat pump body (1210) so as to avoid interference with the thermal management unit (1130) and the refrigerant-coolant heat exchanger (1114).

The first pressure gauge (1117) may be installed on the first refrigerant pipe so as to be connected to the first refrigerant path (1212), and the second pressure gauge (1118) may be installed on the second refrigerant pipe so as to be connected to the fourth refrigerant path (1218).

In addition, the refrigerant-coolant heat exchanger (1114) may be installed on one lower side of the heat pump body (1210) to avoid interference with the thermal management unit (1130) seated on the upper side of the heat pump body (1210). The refrigerant-coolant heat exchanger (1114) may include a first refrigerant-coolant heat exchanger (1114a) and a second refrigerant-coolant heat exchanger (1114b). Portions of the first and second refrigerant-coolant heat exchangers (1114a, 1114b) may be connected to the refrigerant circulation paths (1212, 1214, 1216, 1218) formed inside the heat pump body (1210) in a communicating manner.

Here, the first and second refrigerant-coolant heat exchangers (1114a, 1114b) may receive refrigerant flowing through the refrigerant circulation paths (1212, 1214, 1216, 1218), and exchange heat with the coolant of the thermal management unit (1130). Accordingly, the temperature of the coolant may be regulated using the refrigerant.

The structure of the thermal management unit (1130) according to the present embodiment will now be described in detail with reference to FIGS. 19, 20, and 22˜28.

Referring to FIGS. 19, 20, and 22˜28, the thermal management unit (1130) of the present embodiment may include a coolant control valve (1132), a radiator (1120), coolant pumps (1252, 1254, 1256, 1258), and a valve housing (1220).

The coolant control valve (1132) and the coolant pumps (1252, 1254, 1256, 1258) may be installed in the valve housing (1220). Inside the valve housing (1220), coolant circulation paths (1221˜1241) may be formed. The valve housing (1220) may be seated and fixed on the upper side of the heat pump body (1210) and integrally coupled thereto as a unified structure.

At this time, connection tubes (1500) connected to the coolant circulation paths (1221˜1241) may protrude from the valve housing (1220). Coolant hoses may be respectively connected to the connection tubes (1500), such that they communicate with the battery pack (1140), electrical component module (1150), coolant-to-air heat exchanger (1160), and radiator (1120). Using this configuration, the coolant circulation paths (1221˜1241) in the valve housing (1220) may be connected to enable coolant circulation to the battery pack (1140), electrical component module (1150), coolant-to-air heat exchanger (1160), and radiator (1120).

For example, the valve housing (1220) of the present embodiment may include a lower body (1220a) fixed to the upper side of the heat pump body (1210), and an upper body (1220b) coupled to the upper side of the lower body (1220a).

As shown in FIG. 22, coolant circulation paths (1221˜1241) may be formed inside the lower body (1220a). The lower portion of the lower body (1220a), when seated and coupled to the heat pump body (1210), may pass through the heat pump body (1210) and be connected in communication with the first and second refrigerant-coolant heat exchangers (1114a, 1114b).

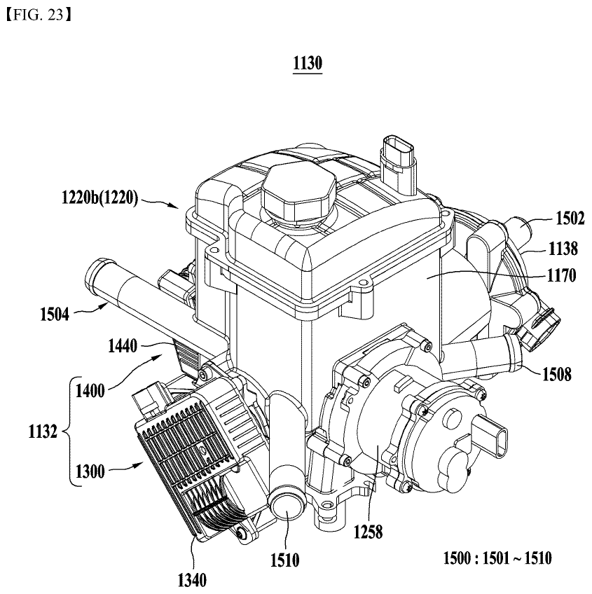

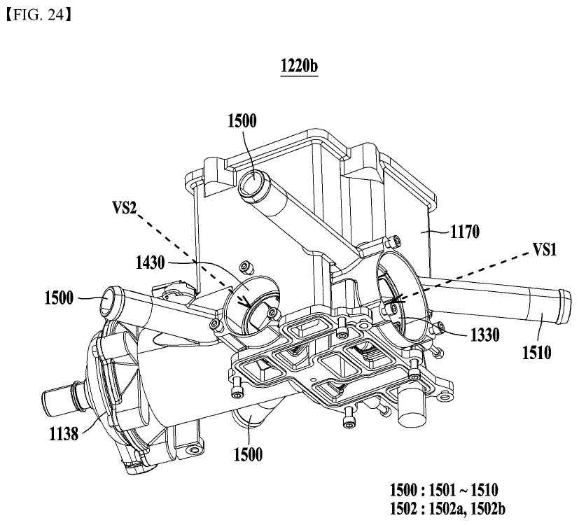

As illustrated in FIGS. 23 and 24, coolant circulation paths (1221˜1241) may also be formed inside the upper body (1220b), which are connected in communication with the coolant circulation paths (1221˜1241) of the lower body (1220a) when the upper body (1220b) and the lower body (1220a) are assembled together.

At this time, the coolant control valves (1132) may be installed in plural on at least one of the upper body (1220b) or the lower body (1220a) such that they are arranged at multiple positions along the coolant circulation paths (1221˜1241) of the valve housing (1220). In the present embodiment, it will be described based on an example where two coolant control valves (1132) are rotatably inserted into the interior of the upper body (1220b).

In addition, the coolant pumps (1252, 1254, 1256, 1258) may be selectively installed on a plurality of connection tubes (1500) formed in the lower body (1220a) and the upper body (1220b).

For example, the connection tubes (1500) may include: a first connection tube (1501) for supplying coolant to the battery pack (1140), a second connection tube (1502) for recovering coolant discharged from the battery pack (1140), a third connection tube (1503) for supplying coolant to the electrical component module (1150), a fourth connection tube (1504) for recovering coolant discharged from the electrical component module (1150), a fifth connection tube (1505) for supplying coolant to the first coolant-to-air heat exchanger (1162), a sixth connection tube (1506) for recovering coolant discharged from the first coolant-to-air heat exchanger (1162), a seventh connection tube (1507) for supplying coolant to the second coolant-to-air heat exchanger (1164), an eighth connection tube (1508) for recovering coolant discharged from the second coolant-to-air heat exchanger (1164), a ninth connection tube (1509) for supplying coolant to the radiator (1120), and a tenth connection tube (1510) for recovering coolant discharged from the radiator (1120).

Here, the second connection tube (1502) may include: an inner tube (1502a) connected to the battery pack (1140), and an outer tube (1502b) arranged to surround the outer circumference of the inner tube (1502a).

In this case, the thermal management unit (1130) of the present embodiment may further include a coolant heater (1138) disposed between the inner tube (1502a) and the outer tube (1502b). The coolant heater (1138) may heat the coolant recovered from the battery pack (1140) when necessary. The coolant heated by the coolant heater (1138) as described above may be delivered to the first coolant-to-air heat exchanger (1162) through the coolant circulation paths (1221˜1241).

Furthermore, the thermal management unit (1130) of the present embodiment may further include coolant pumps (1252, 1254, 1256, 1258) configured to pump the coolant at a predetermined pressure toward the battery pack (1140), the electrical component module (1150), the second coolant-to-air heat exchanger (1162), and the refrigerant-coolant heat exchanger (1114). These coolant pumps may be respectively disposed at the first connection tube (1501), third connection tube (1503), fifth connection tube (1505), and a side portion of the valve housing (1220).

For example, the coolant pumps (1252, 1254, 1256, 1258) may include: a first coolant pump (1252) disposed at the first connection tube (1501), a second coolant pump (1254) disposed at the third connection tube (1503), a third coolant pump (1256) disposed at the fifth connection tube (1505), and a fourth coolant pump (1258) disposed on a side portion of the valve housing (1220).

Additionally, the thermal management unit (1130) of the present embodiment may further include a reservoir (1170) for storing the coolant. The reservoir (1170) as described above may be formed as a chamber within the valve housing (1220). Here, an inlet of the reservoir (1170) may be connected in communication with a second valve groove (1430) (to be described later) via the coolant circulation paths (1221˜1241) and may be opened and closed by the second coolant control valve (1400). Also, an outlet of the reservoir (1170) may be connected to the coolant circulation paths (1221˜1241) and the third connection tube (1503) to be linked to the electrical component module (1150).

Meanwhile, FIGS. 25 to 28 illustrate various drawings of the coolant control valves (1132) of the thermal management unit (1130).

As shown in FIG. 25, the coolant control valve (1132) of the present embodiment may include: a first coolant control valve (1300) rotatably disposed in a first axial direction (VS1) in a first valve groove (1330) formed on one side of the upper body (1220b), and a second coolant control valve (1400) rotatably disposed in a second axial direction (VS2) orthogonal to the first axial direction (VS1), in a second valve groove (1430) formed on the other side of the upper body (1220b).

The first coolant control valve (1300) may be rotated by a predetermined rotation angle (e.g., 72 degrees) so as to selectively open or close at least one of the five ports formed in the first valve groove (1330). The external ports of the first coolant control valve (1300) as described above may be respectively connected, via the coolant circulation paths (1221˜1241), to at least one of the radiator (1120), the electrical component module (1150), the first coolant-to-air heat exchanger (1162), the second refrigerant-to-coolant heat exchanger (1114b), and the external ports of the second coolant control valve (1400).

The second coolant control valve (1400) may be rotated by a predetermined rotation angle (e.g., 90 degrees) so as to selectively open or close at least one of the four ports formed in the second valve groove (1430). The external ports of the second coolant control valve (1400) as described above may be respectively connected, via the coolant circulation paths (1221˜1241), to at least one of the electrical component module (1150), the first coolant-to-air heat exchanger (1162), the second coolant-to-air heat exchanger (1164), the first refrigerant-to-coolant heat exchanger (1114a), the second refrigerant-to-coolant heat exchanger (1114b), the battery pack (1140), and the external ports of the second coolant control valve (1400).

As shown in FIGS. 25 to 27, the first coolant control valve (1300) of the present embodiment may include a first coolant valve (1310), a first actuator (1340), a first coolant valve passage (1317), a second coolant valve passage (1318), and a third coolant valve passage (1319).

The axial direction of the first coolant valve (1310) may be rotatably inserted into the first valve groove (1330) in the first axial direction (VS1). As shown in FIG. 27, the first coolant valve (1310) may be formed such that its diameter (VD1) is greater than its length (VL1) along the first axial direction (VS1). For example, the first coolant valve (1310) may have a disk shape with a large diameter (VD1) and a short length (VL1) along the first axial direction (VS1).

The first actuator (1340) may be connected to a rotational shaft at the upper surface of the first coolant valve (1310) so as to rotate the valve by a predetermined angle. The first actuator (1340) as described above may be fixedly fastened to one side of the upper body (1220b) where the first valve groove (1330) is formed.

The first coolant valve passage (1317) may be formed at a first side portion of the first coolant valve (1310) to connect two adjacent valve ports among the firstfifth valve ports (1311˜1315) formed along the circumferential side of the first valve groove (1330).

The second coolant valve passage (1318) may be formed at a second side portion of the first coolant valve (1310) to connect another pair of adjacent valve ports among the firstfifth valve ports (1311˜1315) formed along the circumferential side of the first valve groove (1330).

The third coolant valve passage (1319) may be formed at a third side portion and a bottom portion of the first coolant valve (1310) to connect the remaining one valve port among the firstfifth valve ports (1311˜1315) and a connection passage (F) formed at an eccentric position on the bottom of the first coolant valve (1310).

Meanwhile, a plurality of first valve holes may be formed spaced apart along the side of the first coolant valve (1310), and a single second valve hole may be eccentrically formed at the bottom of the first coolant valve (1310). The first valve holes may be formed at regular intervals along the periphery of the side portion of the first coolant valve (1310). The second valve hole may be eccentrically disposed at a position offset in the first axial direction (VS1) on the bottom surface of the first coolant valve (1310).

Here, the plurality of first valve holes may form the inlet and outlet of the first coolant valve passage (1317), the inlet and outlet of the second coolant valve passage (1318), and the inlet of the third coolant valve passage (1319). The single second valve hole may form the outlet of the third coolant valve passage (1319).

As illustrated in FIGS. 25 and 27, the first coolant valve passage (1317), the second coolant valve passage (1318), and the third coolant valve passage (1319) may be spaced apart from each other at predetermined angles along a circumferential direction of the first coolant valve (1310). Additionally, the first to fifth valve ports (1311˜1315) may be arranged at predetermined angular intervals along a circumferential surface of the first valve groove (1330).

Here, the first valve port (1311) may be fluidly connected to an outlet side of the second refrigerant-coolant heat exchanger (1114b) and the second coolant-air heat exchanger (1164) through the coolant circulation passage (1221˜1241) and the connection port (1500). The second valve port (1312) may be connected to supply coolant to a fifteenth valve port (1413) of the second coolant control valve (1400), which will be described later, through the coolant circulation passage (1221˜1241). The third valve port (1313) may be fluidly connected to an outlet side of the electrical component module (1150) through the coolant circulation passage (1221˜1241) and the connection port (1500). The fourth valve port (1314) may be fluidly connected to an outlet side of the radiator (1120) through the coolant circulation passage (1221˜1241) and the connection port (1500). The fifth valve port (1315) may be connected to supply coolant to a seventeenth valve port (1421) of the second coolant control valve (1400), which will be described later, through the coolant circulation passage (1221˜1241).

A bottom surface of the first valve groove (1330) may be recessed in a direction away from the first coolant valve (1310) such that a space(S) is formed between the bottom surface of the first valve groove (1330) and the first coolant valve (1310). Here, on an eccentric position of the bottom surface of the first valve groove (1330), an eighth coolant port (1322) may be formed to be connected to an inlet side of the second refrigerant-coolant heat exchanger (1114b) through the coolant circulation passage (1221˜1241). Additionally, ninth to twelfth coolant ports (1323˜1326), which are connected to an inlet side of the radiator (1120) through the coolant circulation passage (1221˜1241) and the connection port (1500), may be formed on other portions of the bottom surface of the first valve groove (1330) excluding the eighth coolant port (1322), such that they are in communication with each other.

At this time, a tubular member (1328) having a larger area than the connection passage (F) may be disposed in the eighth coolant port (1322). One end of the tubular member (1328) may be connected to the eighth coolant port (1322), and the other end of the tubular member (1328) may be in slidable contact with the bottom surface of the first coolant valve (1310). Therefore, the connection passage (F) may be connected to the tubular member (1328) and communicate with the eighth coolant port (1322) when the first coolant valve (1310) rotates, or it may not be connected to the tubular member (1328) and instead communicate with the ninth to twelfth coolant ports (1323˜1326).

As illustrated in FIGS. 25 and 28, the second coolant control valve (1400) of the present embodiment may include a second coolant valve (1410), a second actuator (1440), a fifth coolant valve passage (1415), a sixth coolant valve passage (1416), and a seventh coolant valve passage (1427).

The second coolant valve (1410) may be rotatably inserted into the second valve groove (1430) along a second axial direction (VS2). As illustrated in FIG. 28, the diameter (VD2) of the second coolant valve (1410) may be smaller than a length (VL2) of the second coolant valve (1410) in the second axial direction (VS2). For example, the second coolant valve (1410) may be formed in a cylindrical shape having a small diameter (VD2) and an elongated length (VL2) along the second axial direction (VS2). In this case, the second coolant valve (1410) may be divided into an upper layer, a middle layer, and a lower layer in sequence along the second axial direction (VS2) from the portion connected to the second actuator (1440).

The second actuator (1440) may be connected to a rotation shaft at an upper surface of the second coolant valve (1410) to rotate the second coolant valve (1410) by a predetermined angle. The second actuator (1440) may be fixed to and fastened to the other side of the upper body (1220b) where the second valve groove (1430) is formed.

The fifth coolant valve passage (1415) may be formed in a first region of a side surface of the upper layer of the second coolant valve (1410) to connect two adjacent valve ports among the thirteenth to sixteenth valve ports (1411˜1414) arranged along an upper circumferential surface of the second valve groove (1430).

The sixth coolant valve passage (1416) may be formed in a second region of the side surface of the upper layer of the second coolant valve (1410) to connect another pair of adjacent valve ports among the thirteenth to sixteenth valve ports (1411˜1414) arranged along the upper circumferential surface of the second valve groove (1430).

The seventh coolant valve passage (1427) may be formed in the side surfaces of the lower and middle layers of the second coolant valve (1410) to connect at least one valve port among the seventeenth to twentieth valve ports (1421˜1424) arranged along the circumferential surface of the lower and middle portions of the second valve groove (1430).

As shown in FIGS. 25 and 28, the fifth coolant valve passage (1415) and the sixth coolant valve passage (1416) may be spaced apart along the circumferential direction of the upper layer of the second coolant valve (1410). The seventh coolant valve passage (1427) may be provided by a hollow portion connecting the inside of the middle and lower layers of the second coolant valve (1410), and a hole formed in the outer peripheral wall of the middle and lower layers of the second coolant valve (1410).

In addition, the thirteenth to sixteenth valve ports (1411˜1414) may be disposed at predetermined angular intervals along one side of the second valve groove (1430) corresponding to the upper layer of the second coolant valve (1410), and a plurality of the thirteenth to sixteenth valve ports (1411˜1414) may be disposed spaced apart from each other on the other side of the second valve groove (1430) corresponding to the middle and lower layers of the second coolant valve (1410).

Here, the thirteenth valve port (1411) may be connected to an outlet side of the battery pack (1140) and the first refrigerant-coolant heat exchanger (1162) through the coolant circulation flow path (1221˜1241) and the connection tube (1500). The fourteenth valve port (1412) may be connected to an inlet side of the electric component module (1150) through the coolant circulation flow path (1221˜1241) and the connection tube (1500). The fifteenth valve port (1413) may be connected to the second valve port (1312) of the first coolant control valve (1300) through the coolant circulation flow path (1221˜1241) to receive a supply of coolant. The sixteenth valve port (1414) may be connected to an inlet side of the first refrigerant-coolant heat exchanger (1114a) through the coolant circulation flow path (1221˜1241). The seventeenth valve port (1421) and the eighteenth valve port (1422) may be connected to the fifth valve port (1315) of the first coolant control valve (1300) through the coolant circulation flow path (1221˜1241) to receive a supply of coolant. The nineteenth valve port (1423) and the twentieth valve port (1424) may be connected to an outlet side of the second coolant-air heat exchanger (1164) through the coolant circulation flow path (1221˜1241) and the connection tube (1500).

Meanwhile, the upper layer, middle layer, and lower layer of the second coolant valve (1410) may be formed in a stacked structure along the second axial direction (VS2). The upper layer may be configured to be isolated from the middle layer, and the fifth coolant valve passage (1415) and the sixth coolant valve passage (1416) may be formed therein. The middle layer and the lower layer may be formed in a cylindrical tubular shape having a hollow interior, and a plurality of holes formed in an outer circumferential wall of the cylindrical tube may be interconnected through the hollow portion. Accordingly, the seventh coolant valve passage (1417) may be formed by the plurality of holes and the hollow portion.

As described above, the embodiments of the present invention have been explained with reference to specific elements, limited embodiments, and drawings for the purpose of better understanding of the invention. However, the present invention is not limited to the above-described embodiments. Various modifications and alterations may be made by those skilled in the art to which the invention pertains without departing from the scope of the invention. Therefore, the scope of the present invention should not be construed as being limited to the disclosed embodiments, but shall be defined by the following claims, and all equivalents or modifications thereof shall be construed as falling within the scope of the spirit of the present invention.

1. A thermal management system for an electric vehicle, comprising:
a temperature management unit;
a heat pump unit coupled to a lower side of the temperature management unit; and
a refrigerant-coolant heat exchanger disposed below the heat pump unit and fluidly connected to both the heat pump unit and the temperature management unit,
wherein the temperature management unit comprises:
a valve housing in which a coolant circulation passage is formed and a plurality of connection ports are provided;
a first coolant control valve disposed on one side of the valve housing; and
a second coolant control valve disposed on the other side of the valve housing.

2. The thermal management system of claim 1,
wherein an axial direction of the first coolant control valve is arranged to be orthogonal to an axial direction of the second coolant control valve.

3. The thermal management system of claim 1,
wherein the heat pump unit comprises:
a heat pump body coupled to the lower side of the temperature management unit and having a refrigerant circulation passage formed therein,
wherein the refrigerant-coolant heat exchanger is provided on a lower side of the heat pump body, and
wherein the refrigerant-coolant heat exchanger comprises:
a first refrigerant-coolant heat exchanger; and
a second refrigerant-coolant heat exchanger disposed adjacent to the first refrigerant-coolant heat exchanger.

4. The thermal management system of claim 1,
wherein the temperature management unit further comprises a reservoir formed in a chamber shape within the valve housing,
wherein the valve housing comprises an upper body and a lower body, and
wherein the reservoir is integrally formed at an upper portion of the upper body.

5. The thermal management system of claim 1,
wherein a first valve groove is formed on one side of the valve housing, and
wherein the first coolant control valve comprises:
a first coolant valve inserted in a first axial direction into the first valve groove and having a length in the first axial direction that is shorter than its diameter; and
a first actuator connected to a rotation axis of the first coolant valve.

6. The thermal management system of claim 5,
wherein first valve holes are formed on a side surface of the first coolant valve, and
a second valve hole is formed on a bottom surface of the first coolant valve.

7. The thermal management system of claim 6,
wherein a space is formed between the bottom surface of the first valve groove and the bottom surface of the first coolant valve, and
a tubular member is disposed between the second valve hole and the bottom surface of the first valve groove.

8. The thermal management system of claim 1,
wherein a second valve groove is formed on the other side of the valve housing, and
wherein the second coolant control valve comprises:
a second coolant valve inserted in a second axial direction into the second valve groove and having a length in the second axial direction that is greater than its diameter; and
a second actuator connected to a rotation axis of the second coolant valve.

9. The thermal management system of claim 8,
wherein the second coolant valve comprises an upper layer, an intermediate layer, and a lower layer formed along the second axial direction from a top portion to a bottom portion,
wherein the upper layer is formed as a structure isolated from the intermediate layer, and
wherein the intermediate layer and the lower layer are formed in a hollow cylindrical shape.

10. The thermal management system of claim 1,
wherein the heat pump unit comprises:
a compressor configured to compress a refrigerant;
an expansion valve configured to expand the refrigerant;
a refrigerant switching valve connected between the compressor and the expansion valve and configured to switch a flow direction of the refrigerant; and
a refrigerant bypass unit provided at the refrigerant switching valve and configured to bypass a portion of the refrigerant introduced into the refrigerant switching valve to an inlet side of the compressor.

11. The thermal management system of claim 10,
wherein the heat pump unit further comprises a heat pump body coupled to the lower side of the temperature management unit,
wherein the heat pump body connects the compressor, the expansion valve, the refrigerant switching valve, and the refrigerant bypass unit,
wherein the refrigerant-coolant heat exchanger is provided on a lower side of the heat pump body, and
wherein the compressor is provided in a structure that extends outward from the heat pump body.
